(19) United States
(12) Patent Application Publication
(10) Pub. No.: US 2014/0278418 A1
(43) Pub. Date: Sep. 18, 2014

(54) SPEAKER-IDENTIFICATION-ASSISTED DOWNLINK SPEECH PROCESSING SYSTEMS AND METHODS

(71) Applicant: Broadcom Corporation, Irvine, CA (US)

(72) Inventors: Juin-Hwey Chen, Irvine, CA (US); Robert W. Zopf, Rancho Santa Margarita, CA (US); Bengt J. Borgstrom, Santa Monica, CA (US); Elias Nemer, Irvine, CA (US); Ashutosh Pandey, Irvine, CA (US); Jes Thyssen, San Juan Capistrano, CA (US)

(21) Appl. No.: 14/041,464

(22) Filed: Sep. 30, 2013

Related U.S. Application Data
(60) Provisional application No. 61/872,548, filed on Aug. 30, 2013.
(60) Provisional application No. 61/788,135, filed on Mar. 15, 2013.

(51) Int. Cl. G10L 17/00; G10L 19/00

(52) U.S. Cl. CPC G10L 17/00; G10L 19/0017
USPC 704/246

(57) ABSTRACT

Methods, systems, and apparatuses are described for performing speaker-identification-assisted speech processing in a downlink path of a communication device. In accordance with certain embodiments, a communication device includes speaker identification (SID) logic that is configured to identify the identity of a far-end speaker participating in a voice call with a user of the communication device. Knowledge of the identity of the far-end speaker is then used to improve the performance of one or more downlink speech processing algorithms implemented on the communication device.

### CROSS REFERENCE TO RELATED APPLICATION

This application claims priority to U.S. Provisional Application Ser. No. 61/788,135, filed Mar. 15, 2013, and U.S. Provisional Application Ser. No. 61/872,548, filed Aug. 30, 2013, which are incorporated by reference herein in their entirety.

### BACKGROUND

1. Technical Field

The subject matter described herein relates to speech processing algorithms that are used in digital communication systems, such as cellular communication systems, and in particular to speech processing algorithms that are used in the downlink paths of communication devices, such as the downlink paths of cellular telephones.

2. Description of Related Art

A number of different speech processing algorithms are currently used in cellular communication systems. For example, the downlink paths of conventional cellular telephones may implement speech processing algorithms such as speech decoding, packet loss concealment, speech intelligibility enhancement, acoustic shock protection, and the like. Generally speaking, these algorithms typically all operate in a speaker-independent manner. That is to say, each of these algorithms is typically designed to perform in the same manner regardless of the identity of the speaker that is currently talking in the far-end.

### BRIEF SUMMARY

Methods, systems, and apparatuses are described for performing speaker-identification-assisted speech processing in the downlink path of a communication device, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a communication device that implements speaker-identification-assisted speech processing techniques in accordance with an embodiment.

FIG. 2 is a block diagram of downlink speaker identification logic and downlink speech processing logic of a communication device in accordance with an embodiment.

FIG. 3 is a block diagram of a joint source channel decoding stage in accordance with an embodiment.

FIG. 4 is a flowchart of a method for performing joint source channel decoding based at least in part on the identity of a far-end speaker in accordance with an embodiment.

FIG. 5 is a block diagram of a bit error concealment stage in accordance with an embodiment.

FIG. 6 is a flowchart of a method for performing bit error concealment based at least in part on the identity of a far-end speaker in accordance with an embodiment.

FIG. 7 is a block diagram of a packet loss concealment stage in accordance with an embodiment.

FIG. 8 is a flowchart of a method for performing packet loss concealment based at least in part on the identity of a far-end speaker in accordance with an embodiment.

FIG. 9 is a block diagram of a packet loss concealment stage in accordance with another embodiment.

FIG. 10 is a flowchart of a method for performing constrained soft decision packet loss concealment based at least in part on the identity of a far-end speaker in accordance with an embodiment.

FIG. 11 is a block diagram of a speech intelligibility enhancement stage in accordance with an embodiment.

FIG. 12 is a flowchart of a method for performing speech intelligibility enhancement based at least in part on the identity of a far-end speaker and/or a near-end speaker in accordance with an embodiment.

FIG. 13 is a flowchart of a method for obtaining an estimated level associated with near-end noise in accordance with an embodiment.

FIG. 14 is a block diagram of an acoustic shock protection stage in accordance with an embodiment.

FIG. 15 is a flowchart of a method for performing acoustic shock protection based on determining whether a portion of a speech signal comprises speech or signaling tones using speaker identification in accordance with an embodiment.

FIG. 16 is a flowchart of a method for performing acoustic shock protection based on whether a portion of a speech signal comprises speech or non-speech using speaker identification in accordance with an embodiment.

FIG. 17 is a block diagram of a three-dimensional (3D) audio production stage in accordance with an embodiment.

FIG. 18 is a flowchart of a method for producing 3D audio for a near-end listener based on speaker identification information in accordance with an embodiment.

FIG. 19 is a block diagram of a single-channel noise suppression stage in accordance with an embodiment.

FIG. 20 is a flowchart of a method for performing single-channel noise suppression based at least in part on the identity of a far-end speaker in accordance with an embodiment.

FIG. 21 is a block diagram of a computer system that may be used to implement embodiments described herein.

FIG. 22 is a flowchart of a method for processing a speech signal based on an identity of far-end speaker(s) in a downlink path of a communication device in accordance with an embodiment.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Many of the techniques described herein are described in connection with speech signals. The term “speech signal” is used herein to refer to any audio signal that includes at least some speech but does not necessarily mean an audio signal that includes only speech. In this regard, examples of speech signals may include an audio signal captured by one or more microphones of a communication device during a communication session and an audio signal played back via one or more loudspeakers of the communication device during a communication session. As will be appreciated by persons skilled in the relevant art(s), such audio signals may include both speech and non-speech portions.

Almost all of the various speech processing algorithms used in communication systems today have the potential to perform significantly better if the algorithms could determine with a high degree of confidence at any given time whether the input speech signal is the speech signal uttered by a target speaker. Therefore, embodiments described herein use an automatic speaker identification (SID) algorithm to determine whether the input speech signal at any given time is uttered by a specific target speaker and then adapt various speech processing algorithms accordingly to take the maximum advantage of this information. By using this technique, the entire communication system can potentially achieve significantly better performance. For example, speech processing algorithms in the downlink path of a communication device have the potential to perform significantly better if they know at any given time whether a current frame (or a current frequency band in a current frame) of a speech signal is predominantly the voice of a target speaker.

In particular, a method is described herein. In accordance with the method, speaker identification information that identifies a target speaker is received by one or more speech signal processing stages in a downlink path of a communication device. A respective version of a speech signal is processed by each of the one or more speech signal processing stages in a manner that takes into account the identity of the target speaker. The one or more speech signal processing stages include at least one of a joint source channel decoding stage, a bit error concealment stage, a packet loss concealment stage, a speech intelligibility enhancement stage, an acoustic shock protection stage, and a 3D audio production stage.

A communication device is also described herein. The communication device includes downlink speech processing logic that includes one or more speech signal processing stages. Each of the one or more speech signal processing stages is configured to receive speaker identification information that identifies a target speaker and process a respective version of the speech signal in a manner that takes into account the identity of the target speaker. The one or more speech signal processing stages include at least one of a joint source channel decoding stage, a bit error concealment stage, a packet loss concealment stage, a speech intelligibility enhancement stage, an acoustic shock protection stage, and a 3D audio production stage.

A computer readable storage medium having computer program instructions embodied in said computer readable storage medium for enabling a processor to process a speech signal is further described herein. The computer program instructions include instructions that are executable to perform operations. In accordance with the operations, speaker identification information that identifies a target speaker is received by one or more speech signal processing stages in a downlink path of a communication device. A respective version of a speech signal is processed by each of the one or more speech signal processing stages in a manner that takes into account the identity of the target speaker. The one or more speech signal processing stages include at least one of a joint source channel decoding stage, a bit error concealment stage, a packet loss concealment stage, a speech intelligibility enhancement stage, an acoustic shock protection stage, and a 3D audio production stage.

### II. Example Systems and Methods for Performing Speaker-Identification-Based Speech Processing in a Downlink Path of a Communication Device

FIG. 1 is a block diagram of a communication device 102 that is configured to perform speaker-identification-based speech processing during a communication session in accordance with an embodiment. As shown in FIG. 1, communication device 102 includes one or more microphones 104, uplink speech processing logic 106, downlink speech processing logic 112, one or more loudspeakers 114, uplink speaker identification (SID) logic 116 and downlink SID logic 118. Examples of communication device 102 may include, but are not limited to, a cellular telephone, a personal data assistant (PDA), a tablet computer, a laptop computer, a handheld computer, a desktop computer, a video game system, or any other device capable of conducting a video call and/or an audio-only telephone call.

Microphone(s) 104 may be configured to capture input speech originating from a near-end speaker and to generate an input speech signal 120 based thereon. Uplink speech processing logic 106 may be configured to process input speech signal 120 in accordance with various uplink speech processing algorithms to produce an uplink speech signal 122. Examples of uplink speech processing algorithms include, but are not limited to, acoustic echo cancellation, residual echo suppression, single channel or multi-microphone noise suppression, voice activity detection, wind noise reduction, automatic speech recognition, single channel dereverberation, speech encoding, etc. Uplink speech signal 122 may be processed by one or more components that are configured to encode and/or convert uplink speech signal 122 into a form that is suitable for wired and/or wireless transmission across a communication network. Uplink speech signal 122 may be received by devices or systems associated with far-end speaker(s) via the communication network. Examples of communication networks include, but are not limited to, networks based on Code Division Multiple Access (CDMA), Time Division Multiple Access (TDMA), Frequency Division Multiple Access (TDMA), Frequency Division Duplex (FDD), Global System for Mobile Communications (GSM), Wideband-CDMA (W-CDMA), Time Division Synchronous CDMA (TD-SCDMA), Long-Term Evolution (LTE), Time-Division Duplex LTE (TDD-LTE) system, and/or the like.

Communication device 102 may also be configured to receive a speech signal (e.g., downlink speech signal 124) from the communication network. Downlink speech signal 124 may originate from devices or systems associated with far-end speaker(s). Downlink speech signal 124 may be processed by one or more components that are configured to convert and/or decode downlink speech signal 124 into a form that is suitable for processing by communication device 102. Downlink speech processing logic 112 may be configured to process downlink speech signal 124 in accordance with various downlink speech processing algorithms to produce an output speech signal 126. Examples of downlink speech processing algorithms include, but are not limited to, joint source channel decoding, speech decoding, bit error concealment, packet loss concealment, speech intelligibility enhancement, acoustic shock protection, 3D audio production, etc. Loudspeaker(s) 114 may be configured to play back output speech signal 126 so that it may be perceived by one or more near-end users.

In an embodiment, the various uplink and downlink speech processing algorithms may be performed in a manner that takes into account the identity of one or more near-end speakers and/or one or more far-end speakers participating in a communication session via communication device 102. This is in contrast to conventional systems, where speech processing algorithms are performed in a speaker-independent manner.

In particular, uplink SID logic 116 may be configured to receive input speech signal 120 and perform SID operations based thereon to identify a near-end speaker associated with input speech signal 120. For example, uplink SID logic 116 may obtain a speaker model for the near-end speaker. In one embodiment, uplink SID logic 116 obtains a speaker model from a storage component of communication device 102 or from an entity on a communication network to which communication device 102 is communicatively connected. In another embodiment, uplink SID logic 116 obtains the speaker model by analyzing one or more portions (e.g., one or more frames) of input speech signal 120. Once the speaker model is obtained, other portion(s) of input speech signal 120 (e.g., frame(s) received subsequent to obtaining the speaker model) are compared to the speaker model to generate a measure of confidence, which is indicative of the likelihood that the other portion(s) of input speech signal 120 are associated with the near-end speaker. Upon the measure of confidence exceeding a predefined threshold, an SID-assisted mode may be enabled for communication device 102 that causes the various uplink speech processing algorithms to operate in a manner that takes into account the identity of the near-end speaker. Such downlink speech processing algorithms are described below in Section III.

Likewise, downlink SID logic 118 may be configured to receive a decoded version of downlink speech signal 124 from downlink speech processing logic 112 and perform SID operations based thereon to identify a far-end speaker associated with downlink speech signal 124. For example, downlink SID logic 118 may obtain a speaker model for the far-end speaker. In one embodiment, downlink SID logic 118 obtains a speaker model from a storage component of communication device 102 or from an entity on a communication network to which communication device 102 is communicatively coupled. In another embodiment, downlink SID logic 118 obtains the speaker model by analyzing one or more portions (e.g., one or more frames) of a decoded version of downlink speech signal 124. Once the speaker model is obtained, other portion(s) of the decoded version of downlink speech signal 124 (e.g., frame(s) received subsequent to obtaining the speaker model) are compared to the speaker model to generate a measure of confidence, which is indicative of the likelihood that the other portion(s) of the decoded version of downlink speech signal 124 are associated with the far-end speaker. Upon the measure of confidence exceeding a predefined threshold, an SID-assisted mode may be enabled for communication device 102 that causes the various downlink speech processing algorithms to operate in a manner that takes into account the identity of the far-end speaker. Such downlink speech processing algorithms are described below in subsections A-G.

In an embodiment, a speaker may also be identified using biometric and/or facial recognition techniques performed by logic (not shown in FIG. 1) included in communication device 102 instead of by obtaining a speaker model in the manner previously described.

Each of the speech processing algorithms performed by communication device 102 can benefit from the use of the SID-assisted mode. Multiple speech processing algorithms can be controlled or assisted by the same SID module to achieve maximum efficiency in computational complexity. Uplink SID logic 116 may control or assist all speech processing algorithms performed by uplink speech processing logic 106 for the uplink signal (i.e., input speech signal 120), and downlink SID logic 118 may control or assist all speech processing algorithms performed by downlink speech processing logic 112 for the downlink signal (i.e., downlink speech signal 124). In the case of a speech processing algorithm that takes both the downlink signal and the uplink signal as inputs (such as an algorithm performed by an acoustic echo canceller (AEC)), both downlink SID logic 118 and uplink SID logic 116 can be used together to control or assist such a speech processing algorithm.

It is possible that information obtained by downlink speech processing logic 112 may be useful for performing uplink speech processing and, conversely, that information obtained by uplink speech processing logic 106 may be useful for performing downlink speech processing. Accordingly, in accordance with certain embodiments, such information may be shared between downlink speech processing logic 112 and uplink speech processing logic 106 to improve speech processing by both. This option is indicated by dashed line 128 coupling downlink speech processing logic 112 and uplink speech processing logic 106 in FIG. 1.

In certain embodiments, communication device 102 may be trained to be able to identify a single near-end speaker (e.g., the owner of communication device 102, as the owner will be the user of communication device 102 roughly 95 to 99% of the time). While doing so may result in improvements in speech processing the majority of the time, such an embodiment does not take into account the occasional use of communication device 102 by other users. For example, occasionally a family member or a friend of the primary user of communication device 102 may also use communication device 102. Moreover, such an embodiment does not take into account downlink speech signal 124 received by communication device 102 via the communication network, which keeps changing from communication session to communication session. Furthermore, the near-end speaker and/or the far-end speaker may even change during the same communication session in either the uplink or the downlink direction, as two or more people might use a respective communication device in a conference/speakerphone mode.

Accordingly, uplink SID logic 116 and downlink SID logic 118 may be configured to determine when another user begins speaking during the communication session and operate the various speech processing algorithms in a manner that takes into account the identity of the other user.

FIG. 2 is a block diagram 200 of example downlink SID logic 218 and downlink speech processing logic 212 in accordance with an embodiment. Downlink SID logic 218 may comprise an implementation of downlink SID logic 118 as described above in reference to FIG. 1. In further accordance with such an embodiment, speech signal 224 may correspond to downlink speech signal 124 and downlink speech processing logic 212 may correspond to downlink speech processing logic 112. As discussed above in reference to FIG. 1, downlink SID logic 218 is configured to determine the identity of far-end speaker(s) speaking during a communication session.

Downlink speech processing logic 212 may be configured to process speech signal 224 in accordance with various downlink speech processing algorithms to produce a processed speech signal 236 that is output for playback to the near-end user. The various downlink speech processing algorithms may be performed in a manner that takes into account the identity of one or more far-end speakers participating in a communication session via communication device 102. The downlink speech processing algorithms may be performed by a plurality of respective stages of downlink speech processing logic 212. Such stages include, but are not limited to, a joint source channel decoding (JSCD) stage 220, a speech decoding stage 222, a bit error concealment (BEC) stage 226, a packet loss concealment (PLC) stage 228, a speech intelligibility enhancement (SIE) stage 230, an acoustic shock protection (ASP) stage 232, and a 3D audio production stage 234. Each of these stages is discussed in greater detail below in reference to FIGS. 3-18. Downlink speech processing logic 212 may also include stages in addition to the stages mentioned above. For example, in accordance with certain embodiments, downlink speech processing logic 212 may include a single-channel noise suppression stage, which is discussed in greater detail below in reference to FIGS. 19-20.

As shown in FIG. 2, downlink SID logic 218 includes feature extraction logic 202, training logic 204, one or more speaker models 206, pattern matching logic 208 and mode selection logic 214. Feature extraction logic 202 may be configured to continuously collect and analyze a decoded version of speech signal 224, denoted speech signal 238, to extract feature(s) therefrom during a communication session with another user. That is, feature extraction is done on an ongoing basis during a communication session rather than during a “training mode,” in which a user speaks into communication device 102 outside of an actual communication session with another user. It is noted that feature extraction logic 202 may be configured to collect and analyze other representations of speech signal 224, such as, but not limited to, processed versions of such speech signal output by BEC stage 226 and/or PLC stage 228.

One advantage of continuously collecting and analyzing speech signal 238 is that the SID operations are invisible and transparent to the user (i.e., a “blind training” process is performed on speech signal(s) received by communication device 102). Thus, user(s) are unaware that any SID operation is being performed, and the user of communication device 102 can receive the benefit of the SID operations automatically without having to explicitly “train” communication device 102 during a “training mode.” Moreover, such a “training mode” is only useful for training near-end users, not far-end users, as it would be awkward to have to ask a far-end caller to train communication device 102 before starting a normal conversation in a phone call.

In an embodiment, feature extraction logic 202 extracts feature(s) from one or more portions (e.g., one or more frames) of speech signal 238, and maps each portion to a multidimensional feature space, thereby generating a feature vector for each portion. For speaker identification, features that exhibit high speaker discrimination power, high interspeaker variability, and low intraspeaker variability are desired. Examples of various features that feature extraction logic 202 may extract from speech signal 238 are described in Campbell, Jr., J., “Speaker Recognition: A Tutorial,” Proceedings of the IEEE, Vol. 85, No. 9, September 1997, the entirety of which is incorporated by referenced herein. Such features may include, for example, reflection coefficients (RCs), log-area ratios (LARs), arcsin of RCs, line spectrum pair (LSP) frequencies, and the linear prediction (LP) ceptrsum.

In an embodiment, downlink SID logic 218 may employ a voice activity detector (VAD) to distinguish between a speech signal and a non-speech signal. In accordance with this embodiment, feature extraction logic 202 only uses the active portion of the speech for feature extraction.

Training logic 204 may be configured to receive feature(s) extracted from one or more portions (e.g., one or more frames) of speech signal 238 by feature extraction logic 202 and process such feature(s) to generate a speaker model 206 for a desired speaker (i.e., a far-end speaker that is speaking). In an embodiment, speaker model 206 is represented as a Gaussian Mixture Model (GMM) that is derived from a universal background model (UBM) stored in communication device 102. That is, the UBM serves as a basis for generating a GMM speaker model for the desired speaker. The GMM speaker model may be generated based on a maximum a posteriori (MAP) method, where a soft class label is generated for each portion (e.g., frame) of input signal received. A soft class label is a value representative of a probability that the portion being analyzed is from the target speaker.

When generating a GMM speaker model, speaker-dependent signatures (i.e., feature(s) extracted by feature extraction logic 202) are obtained to predict the presence of a desired source (e.g., a desired speaker) and interfering sources (e.g., noise) in the portion of the speech signal being analyzed. Each portion may be scored against a model of the current acoustic scene using acoustic scene analysis (ASA) to obtain the soft class label. If the soft class labels show the current portion to be a desired source with high likelihood, then the portion can be used to train the desired GMM speaker model. Otherwise, the portion is not used to train the desired GMM speaker model. In addition to the GMM speaker model, the UBM can also be updated using this information to further assist in GMM speaker model generation. In this case, the UBM can be updated with speech portions that are highly likely to be interfering sources so that the UBM provides a more accurate model for the null hypothesis. Moreover, the skewed prior probabilities (i.e., soft class labels) of other users for which speaker models are generated can also be leveraged to improve GMM speaker model generation.

Once speaker model 206 is obtained, pattern matching logic 208 may be configured to receive feature(s) extracted from other portion(s) of speech signal 238 (e.g., frame(s) received subsequent to obtaining speaker model 206) and compare such feature(s) to speaker model 206 to generate a measure of confidence 210, which is indicative of the likelihood that the other portion(s) of speech signal 238 are associated with the user who is speaking. Measure of confidence 210 is continuously generated for each portion (e.g., frame) of speech signal 238 that is analyzed. Measure of confidence 210 may be determined based on a degree of similarity between the feature(s) extracted by feature extraction logic 202 and speaker model 206. The greater the similarity between the extracted feature(s) and speaker model 206, the more likely that speech signal 238 is associated with the user whose voice was used to generate speaker model 206. In an embodiment, measure of confidence 210 is a Logarithmic Likelihood Ratio (LLR), which is the logarithm of the ratio of the conditional probability of the current observation given that the current frame being analyzed is spoken by the target speaker divided by the conditional probability of the current observation given that the current frame being analyzed is not spoken by the target speaker.

Measure of confidence 210 is provided to mode selection logic 214. Mode selection logic 214 may be configured to determine whether measure of confidence 210 exceeds a predefined threshold. In response to determining that measure of confidence 210 exceeds the predefined threshold, mode selection logic 214 may enable an SID-assisted mode for communication device 102 that causes the various downlink speech processing algorithms of downlink speech processing logic 212 to operate in a manner that takes into account the identity of the user that is speaking.

Mode selection logic 214 may also provide speaker identification information to the various downlink speech processing algorithms. In an embodiment, the speaker identification information may include an identifier that identifies the far-end user that is speaking. The various downlink speech processing algorithms may use the identifier to obtain speech models and/or parameters optimized for the identified user and process speech accordingly. In an embodiment, the speech models and/or parameters may be obtained, for example, by analyzing portion(s) of a respective version of speech signal 238. In another embodiment, the speech models and/or parameters may be obtained from a storage component of communication device 102 or from a remote storage component on a communication network to which communication device 102 is communicatively connected. It is noted that the speech models and/or parameters described herein are in reference to speech models and/or parameters used by downlink speech processing algorithm(s) and are not to be interpreted as the speaker models used by downlink SID logic 218 as described above.

In an embodiment, the enablement of the SID-assisted algorithm features may be “phased-in” gradually over a certain range of the measure of confidence. For example, the contributions from the SID-assisted algorithm features may be scaled from 0 to 1 gradually as the measure of confidence increases over a certain predefined range.

Mode selection logic 214 may also enable training logic 204 to generate a new speaker model in response to determining that another user is speaking during the same communication session. For example, when another speaker begins speaking, portion(s) of speech signal 238 that are generated when the other user speaks are compared to speaker model(s) 206. The speaker model that speech signal 238 is initially compared to is the speaker model associated with the user that was previously speaking. As such, measure of confidence 210 will be lower, as the feature(s) extracted from speech signal 238 that is generated when the other user speaks will be dissimilar to the speaker model. In response to determining that measure of confidence 210 is below a predefined threshold, mode selection logic 214 determines that another user is speaking. Thereafter, training logic 204 generates a new speaker model for the new user. When measure of confidence 210 associated with the new speaker reaches the predefined threshold, mode selection logic 214 enables the SID-assisted mode for communication device 102 that causes the various downlink speech processing algorithms to operate in a manner that takes into account the identity of the new far-end speaker.

Mode selection logic 214 may also provide speaker identification information that includes an identifier that identifies the new user that is speaking to the various downlink speech processing algorithms. The various downlink speech processing algorithms may use the identifier to obtain speech models and/or parameters optimized for the new far-end user and process speech accordingly.

Each of the speaker models generated by downlink SID logic 218 may be stored in a storage component of communication device 102 or in an entity on a communication network to which communication device 102 may be communicatively connected for subsequent use.

To minimize any degradation of system performance when a new far-end user begins speaking, downlink speech processing logic 212 may be configured to operate in a non-SID assisted mode as long as the measure of confidence generated by downlink SID logic 218 is below a predefined threshold. The non-SID assisted mode may comprise a default operational mode of communication device 102.

It is noted that even in the case where each user only speaks for a short amount of time before another speaker begins speaking (e.g., in speakerphone/conference mode) and measure of confidence 210 does not exceed the predefined threshold, communication device 102 remains in the default non-SID-assisted mode and will perform just as well as a conventional system without any catastrophic effect.

In an embodiment, downlink SID logic 218 may determine the number of different speakers in the conference call and classify speech signal 238 into N clusters, where N corresponds to the number of different speakers.

After identifying the number of users, downlink SID logic 218 may then train and update N speaker models 206. N speaker models 206 may be stored in a storage component of communication device 102 or in an entity on a communication network to which communication device 102 may be communicatively connected. Downlink SID logic 218 may continuously determine which speaker is currently speaking and update the corresponding SID speaker model for that speaker.

If measure of confidence 210 for a particular speaker exceeds the predefined threshold, downlink SID logic 218 may enable the SID-assisted mode for communication device 102 that causes the various downlink speech processing algorithms to operate in a manner that takes into account the identity of that particular far-end speaker. If measure of confidence 210 falls below a predefined threshold (e.g., when another far-end speaker begins speaking), communication device 102 may switch from the SID-assisted mode to the non-SID-assisted mode.

In one embodiment, speaker model(s) may be stored between communication sessions (e.g., in a non-volatile memory of communication device 102 or an entity on a communication network to which communication device 102 may be communicatively connected). In this way, every time a far-end user for which a speaker model is stored speaks during a communication session, downlink SID logic 218 may recognize the far-end user that is speaking without having to generate a speaker model for that far-end user. In this way, mode selection logic 214 of downlink SID logic 218 can immediately switch on the SID-assisted mode and use the speech models and/or parameters optimized for that particular far-end speaker to obtain the maximum performance improvement when that user speaks. Furthermore, speaker model(s) 206 may be continuously updated as additional communication sessions are carried out.

In the downlink direction, the number of possible speakers is typically larger than in the uplink direction. Thus, it may not be reasonable to try to train and store a speaker model for each far-end speaker, as this would consume a greater amount of memory. Therefore, in an embodiment, downlink SID logic 218 is configured to store a predetermined number of speaker models for far-end speakers. For example, in an embodiment, downlink SID logic 218 may store speaker models for far-end speakers that most frequently engage in a communication session with the primary user of communication device 102 (e.g., friends, family, etc.).

In another embodiment, downlink SID logic 218 may utilize a rating system to track how often a particular speaker engages in a communication session and when such communication session(s) occur (e.g., by tracking the date and/or time of each communication session). In accordance with this embodiment, downlink SID logic 218 may only store speaker models for those speakers that have been in a call more often and/or more recently with the primary user. In an embodiment, the rating system may be based on a weighted sum of the amount of time each speaker spent on each communication session, where the weighting factor for each call decreases with the elapsed time from a particular communication session to the present time.

### III. Example Downlink Speech Processing Algorithms that Utilize Speaker Identification Information

Various downlink speech processing algorithms that utilize speaker identification information to achieve improved performance are described in the following subsections. In particular, Subsection A describes a Joint Source Channel Decoding stage that performs a joint source channel decoding algorithm in a manner that utilizes speaker identification information in accordance with an embodiment herein. Subsection B describes a Speech Decoding stage that performs a speech decoding algorithm in a manner that utilizes speaker identification information in accordance with an embodiment herein. Subsection C describes a bit error concealment stage that performs a bit error concealment algorithm in a manner that utilizes speaker identification information in accordance with an embodiment herein. Subsection D describes a Packet Loss Concealment stage that performs a packet loss concealment algorithm in a manner that utilizes speaker identification information in accordance with an embodiment herein. Subsection E describes a Speaker Intelligibility Enhancement stage that performs a speaker intelligibility enhancement algorithm in a manner that utilizes speaker identification information in accordance with an embodiment herein. Subsection F describes an Acoustic Shock Protection stage that performs an acoustic shock protection algorithm in a manner that utilizes speaker identification information in accordance with an embodiment herein. Lastly, Subsection G describes a 3D Audio Production stage that performs a 3D audio production algorithm in a manner that utilizes speaker identification information in accordance with an embodiment herein.

### A. Joint Source Channel Decoding (JSCD) Stage

FIG. 3 is a block diagram 300 of an example JSCD stage 320 in accordance with an embodiment. JSCD stage 320 is intended to represent a modified version of a joint source channel decoder described in commonly-owned, co-pending U.S. patent application Ser. No. 13/748,904, entitled “Joint Source Channel Decoding Using Parameter Doman Correlation” and filed on Jan. 24, 2013, the entirety of which is incorporated by reference as if fully set forth herein.

JSCD stage 320 comprises an implementation of JSCD stage 220 of downlink speech processing logic 212 and speech signal 324 corresponds to downlink speech signal 224 as described above in reference to FIG. 2.

JSCD stage 320 is configured to perform joint source channel decoding based at least in part on the identity of the far-end user during a communication session. As shown in FIG. 3, JSCD stage 320 includes a turbo decoder 306, one or more Packet Redundancy Analysis Blocks (PRAB(s)) 308 and one or more speech models 310. As shown in FIG. 3, JSCD stage 320 receives soft bit information (which may or may not be encrypted), and turbo decoder 306 performs its decoding operations based on the received soft bit information and based on extrinsic data inputs received from PRAB(s) 308.

Turbo decoder 306 may be configured to perform iterative decoding of data bits of a data packet that represent a source signal (e.g., speech signal 324) to converge on a soft decision representation (e.g., a real number value) for each of the data bits that represents a likelihood of the respective data bit to be a logical “1” or a logical “0”. In example embodiments, turbo decoder 306 may include two or more decoders which operate collaboratively in order to refine and improve the estimate (i.e., the soft decision) of each of the originally-received data bits over one or more iterations until the soft decisions converge on a stable set of values or until a preset maximum number of iterations is reached. Each decoder may be injected with extrinsic information (e.g., determined by the other decoder, based on a-priori information and/or based on speech model(s) 310).

For a given decoder within turbo decoder 306, the data bits and the corresponding parity bits are included in data packet(s) that carry speech signal 324, and the extrinsic information may be determined and provided by the other decoder and/or PRAB(s) 308 that determine extrinsic information based on a-priori information regarding speech signal 324 and/or information based on speech model(s) 310. JSCD stage 320 is capable of reducing (e.g., avoiding) positive feedback of extrinsic information from one decoder to the other by subtracting out such extrinsic information from the soft decision of the particular decoder during any given iteration.

The resulting decoded data based on the hard decision of turbo decoder 306 is re-inserted into the data stream and provided as part of processed speech signal 326.

Further details concerning an example turbo decoder that supports JSCD, such as that shown in FIG. 3 or alternative implementations thereof, may be found in commonly-owned, co-pending U.S. patent application Ser. No. 13/749,187, entitled “Modified Joint Source Channel Decoder” and filed on Jan. 24, 2013, the entirety of which is incorporated by reference as if fully set forth herein.

PRAB(s) 308 may be configured to determine and provide extrinsic information to turbo decoder 306 by utilizing a-priori information (e.g., redundancy in speech signal 324 and the packet headers of the data packet(s) used to carry speech signal 324), along with soft decisions received from turbo decoder 306. In an embodiment, PRAB(s) 308 may use an A-priori Speech Statistics Algorithm (ASSA) that uses a-priori speech information to improve the soft decisions provided by turbo decoder 306 and provide extrinsic information accordingly. An exemplary ASSA is described in the aforementioned U.S. patent application Ser. No. 13/748,904, the entirety of which has been incorporated by reference herein.

In an embodiment, PRAB(s) 308 may also provide extrinsic information based on speech model(s) 310 that are obtained for each target speaker (e.g., one or more far-end speakers) during a communication session. For example, speech model(s) 310 may be speaker-dependent PDF(s) that are generated during a communication session (as opposed to PDF(s) that are generated off-line and are speaker-independent).

Speech model(s) 310 may model what a particular speech parameter tends to be most of the time for a particular target speaker. Different speech models of the speech parameters may be obtained for different speakers. One example is a speech model based on the pitch period. A high-pitched female or child speaker will have a pitch period-based speech model with greater probabilities in the smaller pitch period, while a low-pitched male speaker will have a pitch-period speech model with greater probabilities in the larger pitch periods. Speech model(s) 310 may also be obtained for other speech parameters, including, but not limited to a vocal tract of a target speaker, pitch range of the target speaker and/or an articulation of the target speaker.

Different speakers will also have different trajectories of speech parameters as functions of time. Accordingly, speech model(s) 310 may also indicate how one or more speech parameters associated with a particular target speaker changes over time. For example, if downlink SID logic 218 monitors whether each portion (e.g., each frame) of far-end speech belongs to a particular target far-end speaker, then over time JSCD stage 320 can use such speaker identification results to analyze the typical trajectories for the time evolution of speech parameters for that particular target far-end speaker. By using such speech models that are specifically optimized for that target far-end speaker, JSCD stage 320 will be able to achieve better performance than using speaker-independent PDFs averaged over the general public.

In an embodiment, JSCD stage 320 generates speech model(s) 310 in response to receiving speaker identification information. For example, the speaker identification information may include an identifier that identifies the target speaker. In response to receiving the speaker identification information, JSCD stage 320 may analyze speech parameters associated with speech signal 324 and build speech model(s) 310 for the identified target speaker. A running-average type approach may be used to build speech model(s) 310.

In an embodiment, speaker identification information may also include measures of confidence for target speakers that may be associated with speech signal 324. In such an embodiment, JSCD stage 320 may use a weighted combination of speech model(s) 310 and/or a weighted combination of speech model(s) 310 and the speaker-independent PDFs to obtain extrinsic information. For example, when a user (e.g., User A) begins speaking, downlink SID logic 218 may generate and provide a first measure of confidence that is indicative of the likelihood that speech signal 324 is associated with User A and a second measure of confidence that is indicative of the likelihood that speech signal 324 is associated with a generic user. For illustrative purposes, the first measure of confidence may indicate a likelihood of 20% that the person speaking is User A, and the second measure of confidence may indicate a likelihood of 80% that the person speaking is a generic user. Accordingly, JSCD stage 320 may use a weighted combination of a speech model 310 associated with User A and the speaker-independent PDF based on the measures of confidence. As the measure of confidence indicating that the person speaking is User A increases over time, the contribution attributed to speech model 310 of User A also increases (as the contribution attributed to the speaker-independent PDF decreases).

Accordingly, in embodiments, JSCD stage 320 may operate in various ways to perform joint source channel decoding based at least in part on the identity of the far-end user during a communication session. FIG. 4 depicts a flowchart 400 of an example method for performing joint source channel decoding based at least in part on the identity of the far-end user during a communication session. The method of flowchart 400 will now be described with continued reference to FIG. 3, although the method is not limited to that implementation. Other structural and operational embodiments will be apparent to persons skilled in the relevant art(s) based on the discussion regarding flowchart 400.

As shown in FIG. 4, the method of flowchart 400 begins at step 402, in which a speech model is obtained that is specific to the target speaker. The speech model may indicate likely values of speech parameter(s) or how speech parameter(s) associated with the target speaker changes over time. For example, with reference to FIG. 3, speech model 310 is obtained for a target speaker (e.g., a far-end target speaker) that is identified by the speaker identification information. Speech model 310 may be obtained by analyzing various speech parameter(s) associated with speech signal 324. Speech model 310 is obtained during the communication session with the far-end target speaker (as opposed to being obtained off-line). After obtaining speech model 310, speech model 310 may be stored in a storage component of communication device 102 or in an entity on a communication network to which communication device 102 is communicatively connected and may be retrieved in the event that the target far-end speaker is identified in a subsequent communication session.

At step 404, joint source channel decoding operations are performed on the speech signal using the obtained speech model. With reference to FIG. 3, turbo decoder 306 performs joint source channel decoding operations on speech signal 324 based on speech model(s) 310. For example, PRAB(s) 308 may obtain extrinsic information based on speech model(s) 310 and provide the extrinsic information to turbo decoder 306 for processing.

### B. Speech Decoding Stage

Speech decoding stage 222 may be configured to perform speech decoding operations based at least in part on the identity of the far-end user during a communication session. For example, downlink SID logic 218 may provide speaker identification information that identifies the target far-end speaker to speech decoding stage 222, and speech decoding stage 222 may decode a received speech signal in a manner that uses such speaker identification information. For example, in an embodiment, a configuration of a speech decoder may be modified by replacing a speaker-independent quantization table or codebook with a speaker-dependent quantization table or codebook or replacing a first speaker-dependent quantization table or codebook with a second speaker-dependent quantization table or codebook. In another embodiment, a configuration of a speech decoder may be modified by replacing a speaker-independent decoding algorithm with a speaker-dependent decoding algorithm or replacing a first speaker-dependent decoding algorithm with a second speaker-dependent decoding algorithm. It is noted that the modification(s) described above may require corresponding modification(s) to a speech encoder (e.g., included in uplink speech processing logic 106 as shown in FIG. 1 and/or included in a far-end communication device) in order to ensure proper encoder and decoder performance.

In yet another embodiment, the configuration of a speech decoder may be modified by implementing post-filtering operations that are carried out in a speaker-dependent manner. Further details concerning how a speech signal may be decoded in a speaker-dependent manner may be found in commonly-owned, co-pending U.S. patent application Ser. No. 12/887,329 (Attorney Docket No. A05.01180002), entitled “User Attribute Derivation and Update for Network/Peer Assisted Speech Coding” and filed on Sep. 21, 2010, the entirety of which is incorporated by reference as if fully set forth herein.

### C. Bit Error Concealment (BEC) Stage

BEC stage 226 may be configured to perform bit error concealment operations based at least in part on the identity of the far-end user during a communication session. FIG. 5 is a block diagram 500 of an example BEC stage 526 in accordance with such an embodiment. BEC stage 526 is intended to represent a modified version of a BEC system described in commonly-owned U.S. Pat. No. 8,301,440, entitled “Bit Error Concealment for Audio Coding Systems” and filed on Apr. 28, 2009, the entirety of which is incorporated by reference as if fully set forth herein.

BEC stage 526 comprises an implementation of BEC stage 226 of downlink speech processing logic 212 as described above in reference to FIG. 2. BEC stage 526 receives speech signal 508. Speech signal 508 may be a version of a far-end speech signal (e.g., speech signal 224 as shown in FIG. 2) that was previously-processed by one or more downlink speech processing stages. In an embodiment, speech signal 508 comprises a decoded speech signal, such as speech signal 238 that is output by speech decoding stage 222 in FIG. 2.

As shown in FIG. 5, BEC stage 526 includes bit error rate (BER)-based threshold biasing block 502, bit error detection block 504 and bit error concealment block 506. Speech signal 508 is received by BER-based threshold biasing block 502 and bit error detection block 504. BER-based threshold biasing block 502 may be configured to analyze non-speech segments of speech signal 508 to estimate a rate at which audible distortions (e.g., clicks) are detected and adapts at least one biasing factor based on the estimated rate. The at least one biasing factor is used to determine a sensitivity level for detecting whether a portion (e.g., a frame) of speech signal 508 includes the distortion. BER-based threshold biasing block 502 provides the at least one biasing factor to bit error detection block 504 for use thereby.

In an embodiment, BER-based threshold biasing block 502 uses an energy-based voice activity detection (VAD) system (not shown) to estimate a click detection rate during periods of speech inactivity in speech signal 508. In particular, using the VAD system, BER-based threshold biasing block 502 continuously updates an estimated click-causing bit error rate during periods of speech inactivity and uses this rate to set the operating point for detection. BER-based threshold biasing block 502 holds the estimated click-causing bit error rate constant during periods of active speech.

Bit error detection block 504 may be configured to detect clicks in speech signal 508 caused by bit errors, while at the same time minimizing false detections caused by portions of speech signal 508 that are mistaken for clicks. During active speech portions, bit error detection block 504 analyzes speech signal 508 in terms of various parameters or statistics such as the pitch and the pitch track, multi-tap pitch prediction analysis, (LPC) analysis, zero crossing rate, derivation of a voicing strength measure, etc. All of these parameters or statistics may be used on their own or used to modify speech signal 508 in some manner such as filtering. A decision is then made based on the analysis of these parameters or statistics as to whether or not the current portion of speech signal 508 contains distortion caused by bit errors.

Bit error concealment block 506 receives a determination from bit error detection block 504 that indicates whether a portion of speech signal 508 contains bit error-induced distortion. In response to receiving an indication that the portion of speech signal 508 contains bit error-induced distortion, bit error concealment block 506 may operate to correct the corrupted portion. In an embodiment, bit error concealment block 506 may declare the entire frame or packet lost and invoke a packet loss concealment technique. However, other techniques to conceal the bit-error induced distortion may be used. For example, bit error concealment block 506 may only correct only those speech signal samples that are determined to be corrupted.

The resulting output signal provided by bit error concealment block 506 (i.e., processed speech signal 510) is provided to subsequent downlink speech processing stages for further processing.

Further details concerning an example BER-based threshold biasing block, bit error detection block and bit error concealment block may be found in the aforementioned U.S. Pat. No. 8,301,440, the entirety of which has been incorporated by reference herein.

BEC stage 526 may be improved using SID in various ways. For example, the aforementioned VAD system included in BER-based threshold biasing block 502 may be improved using SID. For example, for each portion (e.g., frame) of speech signal 508, BER-based threshold biasing block 502 may receive speaker identification information from downlink SID logic 218 that includes a measure of confidence that indicates the likelihood that the particular portion of speech signal 508 is associated with a target speaker. It is likely that the measure of confidence will be relatively higher for portions including active speech and will be relatively lower for portions not including speech. Accordingly, the VAD system may use the measure of confidence to more accurately determine whether or not a particular portion of speech signal 508 contains active speech.

The detection of clicks performed by bit error detection block 504 may also be improved using SID. For example, bit error detection block 504 may be configured to use a measure of confidence received from downlink SID logic 218 to determine whether a click has been detected. For instance, when a portion of speech signal 508 is free of bit error-induced pulses or distortion, the measure of confidence indicating that the likelihood that speech signal 508 is associated with a target far-end speaker will likely be higher than in the scenario when the same portion of speech signal 508 is corrupted by bit error-induced pulses or distortion.

As an example, some speech onsets have a pulse-like waveform at the beginning of a talk spurt, which may be mistakenly detected as a click or noise pulse caused by bit errors. If there are really no bit errors in the current portion that contains such a pulse-like speech waveform, downlink SID logic 218 is likely to provide a higher measure of confidence as compared to a portion containing such a bit error-induced pulse. Thus, if SID is not used, such a portion of speech onset may be declared by bit error detection block 504 as containing a bit error-induced pulse, and the subsequent bit error concealment operation most likely will erroneously apply concealment to the current speech onset frame. On the other hand, if SID is used, it is more likely that bit error detection block 504 will determine that the portion of speech signal 508 is without bit errors, and the portion will be preserved. In this way, SID can help BEC operations improve the output speech quality.

Additionally, both the derivation of the aforementioned parameters or statistics and their subsequent interpretation can be improved if performed on a speaker-dependent basis. For example, with regard to the pitch track, a pitch “jump” may occur when there is a noise pulse. As a result, it is likely that the pitch will be computed incorrectly. The more continuous and well-behaved the pitch was prior to the pitch “jump”, the more likely this jump is an indication of an error. Different speakers will have different pitch contours. For example, one speaker may have a rather monotone voice with a very constant pitch track, while another person may have a widely varying pitch track. Still others may have a very deep voice characterized by vocal fry, which will have a pitch track that constantly jumps around, even during “voiced” speech. This will result in different thresholds based on the pitch track to decide if the pitch jump is likely due to bit-errors or just a natural phenomenon. That is, the threshold used to determine whether a pitch jump has occurred may vary based on the determined pitch track.

For example, bit error detection block 504 may be configured to analyze a pitch history of speech signal 508, assign the pitch history to one of a plurality of pitch track categories (e.g., random, tracking or transitional) based on the analysis and modify a sensitivity level for detecting whether the portion of speech signal 508 includes the distortion based on the pitch track category assigned to the pitch history. The threshold used to determine whether a pitch jump has occurred takes into account the assigned pitch track category.

In an embodiment, the pitch track classification process may factor in a measure of confidence received from downlink SID logic 218 to determine whether or not a pitch jump has occurred. For example, when a portion of speech signal 508 includes a potential pitch jump, bit error detection block 504 may analyze the measure of confidence to determine whether the portion is associated with the target far-end speaker. If the measure of confidence is relatively high, bit error detection block 504 may classify the pitch track as being tracking or transitional, rather than being random. In contrast, if the measure of confidence is relatively low, bit error detection block 504 may classify the pitch track as being random, rather than being tracking or transitional. The threshold is set in accordance to the pitch track classification. Accordingly, by using SID, the pitch track may be more accurately determined using speaker-dependent characteristics.

With regard to the voicing strength measure, bit error detection logic 504 may calculate a voicing strength measure associated with speech signal 508 and modify a sensitivity level for detecting whether the speech portion includes the distortion based on the voicing strength measure. For example, during voiced speech, this measure ideally approaches one, and during unvoiced speech approaches zero. However, some talkers will have voicing strength measures that do not approach one even during voiced speech. This may be due to a dynamic pitch track, relatively high levels of high frequency content, strong formants, etc.

By using SID, the dynamics of the voicing strength measure can be properly taken into account when calculating the expected value for the voicing strength measure for a far-end speaker. For example, a higher measure of confidence may weigh the measure of confidence closer to one, and a lower measure of confidence may weigh the measure closer to zero. Accordingly, by using SID, the voicing strength measure may be more accurately determined using speaker-dependent characteristics.

Accordingly, in embodiments, BEC stage 526 may operate in various ways to perform bit error concealment based at least in part on the identity of the far-end speaker during a communication session. FIG. 6 depicts a flowchart 600 of an example method for performing bit error concealment based at least in part on the identity of the far-end speaker during a communication session. The method of flowchart 600 will now be described with continued reference to FIG. 5, although the method is not limited to that implementation. Other structural and operational embodiments will be apparent to persons skilled in the relevant art(s) based on the discussion regarding flowchart 600.

As shown in FIG. 6, the method of flowchart 600 begins at step 602, in which a portion of a far-end speech signal is analyzed to detect whether the portion includes a distortion that will be audible during playback thereof. The detection is based at least in part on the speaker identification information. For example, with reference to FIG. 5, bit error detection block 504 analyzes a portion of speech signal 508 to detect whether the portion includes a distortion that will be audible during playback thereof.

Depending upon the implementation, step 602 may include using a measure of confidence included in the speaker identification information logic 218 to detect whether the portion includes distortion.

Step 602 may also include improving the operation of a VAD system included in BER-based threshold biasing block 502 to obtain a biasing factor that is then used to detect whether the portion of the speech signal includes a distortion that will be audible during playback thereof.

Step 602 may likewise include improving the manner in which certain speech-related parameters or statistics are derived and/or interpreted by bit error detection block 504 based upon speaker identification information as discussed above.

For example, step 602 may include analyzing a pitch history of speech signal 508 based on speaker identification information that includes a measure of confidence that indicates a likelihood that portion(s) of speech signal 508 are associated with a target far-end speaker, assigning the pitch history to one of a plurality of pitch track categories based on the analysis and modifying a sensitivity level for detecting whether the portion(s) of speech signal 508 include the distortion based on the pitch track category assigned to the pitch history.

As another example, step 602 may include calculating a voicing strength measure associated with the portion(s) of speech signal 508 and modifying a sensitivity level for detecting whether the portion(s) include the distortion based on the voicing strength measure. The voicing strength measure may be determined based on speaker identification information that includes the measure of confidence.

At step 604, the distortion in the far-end speech signal is concealed in response to determining that the far-end speech signal includes the distortion. For example, with reference to FIG. 5, bit error concealment block 506 conceals the distortion in speech signal 508 in response to determining that speech signal 508 includes the distortion. In an embodiment, bit error concealment block 506 performs this step by replacing frame(s) including the distortion with synthesized speech frame(s) generated in accordance with a packet loss concealment algorithm.

### D. Packet Loss Concealment (PLC) Stage

When a portion (e.g., a packet or a frame) of a far-end speech signal is lost during the transmission of the speech signal through a packet network or wireless network, PLC stage 228 may apply a packet loss concealment (PLC) or frame erasure concealment (FEC) algorithm to try and minimize the perceptual degradation of the speech quality by generating a synthesized speech waveform to fill up the waveform gap due to such a packet loss or frame erasure. As will be described below, the PLC performance of PLC stage 228 can be improved by taking into account the identity of a target far-end speaker during a communication session.

FIG. 7 is a block diagram 700 of an example PLC stage 728 in accordance with such an embodiment. PLC stage 728 comprises an implementation of PLC stage 228 of downlink speech processing logic 212 as described above in reference to FIG. 2.

PLC stage 728 receives speech signal 714. Speech signal 714 may be a version of a far-end speech signal (e.g., speech signal 224 as shown in FIG. 2) that was previously-processed by one or more downlink speech processing stages (e.g., JSCD stage 220, speech decoding stage 222, and/or BEC stage 226 as shown in FIG. 2).

In an embodiment, PLC stage 728 is configured to use different concealment strategies (e.g., extrapolation, interpolation, etc.) based on a classification of one or more portion(s) of speech signal 714. The classification process may be improved by taking into account the identity of a target far-end speaker. In accordance with such an embodiment, PLC stage 728 includes a classifier 702, control logic 704, at least a first and second PLC technique 706 and 708, switches 718, 720 and 722 and buffer 724.

As shown in FIG. 7, if a current portion of speech signal 714 is deemed received, switch 722 is placed in the upper position, and the current portion of speech signal 714 is provided as an output speech signal (i.e., processed speech signal 716) that is provided to subsequent downlink speech processing stages for further processing. Switch 722 is controlled by a bad frame indicator, which indicates whether the current portion of speech signal 714 is deemed received or lost. If the current portion of speech signal 714 is deemed lost, then switch 722 is placed in the lower position. In this case, classifier 702 and control logic 704 operate together to select one of at least two PLC techniques to perform the necessary PLC operations.

Classifier 702 may be configured to analyze previously-received portions (e.g., frames) of speech signal 714 (e.g., that are stored in buffer 724) in order to determine whether the current portion of speech signal 714 should be classified as being either active speech or background noise using the speaker identification information. For example, for each portion of speech signal 714, classifier 702 may receive speaker identification information that includes a measure of confidence from downlink SID logic 218 that indicates the likelihood that the particular portion of speech signal 714 is associated with a target far-end speaker. It is likely that the measure of confidence will be relatively higher for portions including active speech and will be relatively lower for portions that comprise background noise. Accordingly, classifier 702 may use the measure of confidence to more accurately determine whether or not a particular portion of speech signal 714 contains active speech.

Control logic 704 selects the PLC technique for the current portion of speech signal 714 based on a classification output from classifier 702. Control logic 704 selects the PLC technique by generating a signal (labeled “PLC Technique Decision”) that controls the operation of switches 718 and 720 to apply either first PLC technique 706 or second PLC technique 708. In the particular example shown in FIG. 7, switches 718 and 720 are in the uppermost position so that first PLC technique 706 is selected. Of course, this is just an example. For a different portion that is lost, control logic 704 may select second PLC technique 708.

Once a particular PLC technique is selected, this selected PLC technique and performs the associated PLC operations, which may involving using the previous portion(s) of speech signal 714 that are stored in buffer 724. The resulting output signal (i.e., processed speech signal 716) is then routed through switches 720 and 722 and is provided to subsequent downlink speech processing stages for further processing.

Persons skilled in the relevant art(s) will readily appreciate that the placing of switches 718, 720 and 722 in an upper or lower position as described herein is not necessarily meant to denote the operation of a mechanical switch, but rather to describe the selection of one of two logical processing paths within PLC stage 728.

First PLC technique 706 may be configured to perform PLC operations that conceal a lost portion that was classified as being active speech. For example, in an embodiment, first PLC technique 706 may replace the lost portion of speech signal 714 with a concealment signal that is obtained by extrapolating previous portions of speech signal 714.

Second PLC technique 708 may be configured to perform PLC operations that conceal a lost portion of speech signal 714 that was classified as being background noise. For example, in an embodiment, second PLC technique 708 may generate pseudo-random white noise to replace the lost background noise.

In an embodiment, first PLC technique 706 and/or second PLC technique 708 conceal a lost frame by extrapolating or interpolating one or more parameter(s) of the underlying speech coder used to encode speech signal 714, rather than directly extrapolating or interpolating the speech waveform. Such parameter(s) may include, but are not limited to, the pitch period, pitch predictor tap (sometimes called adaptive codebook gain in certain types of speech coders), excitation gain, and LSPs, which are also called Line Spectrum Frequencies (LSFs). In accordance with such an embodiment, first PLC technique 706 and/or second PLC technique 708 synthesizes the speech waveform in the lost packet/frame by using the extrapolated or interpolated speech parameters. For parameter extrapolation, previous portion(s) of speech signal 714 is used to estimate the lost parameter(s). If future portion(s) of speech signal 714 are available, then both past and future portion(s) may be used to estimate the lost parameter.

Some of these speech coder parameters have their physical meanings corresponding to the human speech production system. Different speakers have different speech production systems in terms of the vocal cords, vocal tract, nasal tract, etc., and they also have different ways of speaking in terms of the pitch range, pitch contour, gain contour, formant track, etc. However, conventional parameter-based PLC techniques typically repeat the parameters from the last received, good frame or packet, ramp the gain down toward zero after a few lost portions, and/or move the LSPs toward the mean values.

In contrast to such conventional PLC techniques, PLC stage 728 may analyze these parameters associated with portions(s) of speech signal 714 to obtain speech model(s) 710 of the speech parameter(s) for different speakers. Speech model(s) 710 may also indicate how speech parameter(s) associated with the target far-end speaker changes over time. For example, if downlink SID logic 218 monitors whether each portion of a far-end speech signal belongs to a particular target far-end speaker, then over time PLC stage 728 can use such speaker identification results to analyze the typical trajectories for the time evolution of speech parameter(s) for that particular target far-end speaker. Accordingly, when a portion of speech signal 714 is lost, rather than performing a parameter repeat or linear interpolation, first PLC technique 706 and/or second PLC technique 708 may instead use speech model(s) 710 to produce better extrapolated or interpolated speech parameter(s) that are tailored to the target far-end speaker, thereby leading to better output speech quality.

Accordingly, in embodiments, PLC stage 728 may operate in various ways to perform packet loss concealment based at least in part on the identity of the far-end speaker during a communication session. FIG. 8 depicts a flowchart 800 of an example method for performing packet loss concealment based at least in part on the identity of the far-end speaker during a communication session. The method of flowchart 800 will now be described with continued reference to FIG. 7, although the method is not limited to that implementation. Other structural and operational embodiments will be apparent to persons skilled in the relevant art(s) based on the discussion regarding flowchart 800.

As shown in FIG. 8, the method of flowchart 800 begins at step 802, in which at least a portion of a far-end speech signal is classified using speaker identification information. For example, with reference to FIG. 7, classifier 702 classifies a portion of speech signal 714 based on speaker identification information.

For instance, in accordance with an embodiment, classifier 702 analyzes previously-received portions of speech signal 714 in order to determine whether the current portion of speech signal 714 should be classified as being either active speech or background noise using the measure of confidence received via the speaker identification information. The measure of confidence will be relatively higher for portions including active speech and will be relatively lower for portions that comprise background noise. Accordingly, classifier 702 uses the measure of confidence to more accurately determine whether or not a particular frame of speech signal 714 contains active speech.

At step 804, one of a plurality of packet loss concealment techniques are selectively applied to replace a lost portion of the far-end speech signal based on the classification. For example, with reference to FIG. 7, either first PLC technique 706 or second PLC technique 708 is selectively applied to replace a lost portion of speech signal 714 based on the classification performed by classifier 702.

Referring again to FIG. 2, PLC stage 228 may be configured to perform constrained soft-decision packet loss concealment (CSD-PLC). In a typical PLC implementation, as described above, a bad frame indicator signals that a portion of a speech signal contains bit errors, in which case a synthesized speech waveform is generated that is used to conceal the missing portion. In contrast, in a soft bit decoding approach, bit reliability (soft bit) information is exploited. For example, a speech decoder may be modified to use the soft bits in a manner that weights the reconstruction according to how reliable the corresponding bits are. In accordance with various embodiments, the soft bits may be derived from a channel decoding process (e.g., a joint source channel decoding process performed by JSCD stage 220), and can additionally incorporate a priori knowledge of the speech codec parameters.

Soft bit speech decoding takes advantage of the fact that most of the bits in a bad portion of a speech signal may not contain errors. There is a significant loss of information when a conventional PLC implementation throws away the received bits in a bad portion and instead relies on repetition, extrapolation, or interpolation of speech codec parameters and/or the speech signal to replace a missing portion. However, for the bits that do contain errors, there is a risk with soft bit decoding that decoding the corresponding parameter will result in an audible, and sometimes unacceptable, artifact. On average, the speech quality may be improved, but if the worst case artifacts are unacceptable, the technique has limited or no practical value.

In order to address this issue, the CSD-PLC technique employs what is referred to as parameter constraint. Details concerning an example CSD-PLC technique may be found in commonly-owned, co-pending U.S. patent application Ser. No. 13/748,949, entitled “Constrained Soft Decision Packet Loss Concealment” and filed on Jan. 24, 2013, the entirety of which is incorporated by reference as if fully set forth herein. As described in the aforementioned patent application, constraints on certain speech codec parameters are applied based on the natural evolution of such parameters. These constraints are obtained through offline training using a large speech database.

In contrast to such a CSD-PLC technique, embodiments described herein obtain parameter constraints that are specifically tuned to the target far-end speaker. Thus, these parameter constraints can be more effective than the parameter constraints derived off-line from the speech of the general public, and the resulting output speech quality can be improved because the CSD-PLC technique detects and corrects more corrupted speech parameter values than if it uses the off-line-designed parameter constraints that are optimized for general public.

To help illustrate this, FIG. 9 provides a block diagram 900 of an example PLC stage 928 in accordance with such an embodiment. PLC stage 928 is intended to represent a modified version of the CSD-PLC logic described in the aforementioned U.S. patent application Ser. No. 13/748,949, the entirety of which has been incorporated by reference herein.

PLC stage 928 comprises an implementation of PLC stage 228 of downlink speech signal processing logic 212 as described above in reference to FIG. 2. PLC stage 928 receives speech signal 914. Speech signal 914 may be a version of a far-end speech signal (e.g., speech signal 224 as shown in FIG. 2) that was previously-processed by one or more downlink speech processing stages (e.g., JSCD stage 220, speech decoding stage 222, and/or BEC stage 226 as shown in FIG. 2). As shown in FIG. 9, PLC stage 928 includes soft bit decoding logic 902, parameter constraint logic 904, speech decoding logic 906 and speech model(s) 908.

It is to be understood that the operations performed by PLC stage 928 may be performed in response to a determination that an encoded portion (e.g., frame) that represents a segment of speech signal 914 and that has been received over a communication channel is bad. As used herein, the statement that the encoded frame is determined to be “bad” is meant to broadly encompass any determination that the encoded frame is not suitable for standard speech decoding. For example, the encoded frame may be determined to be bad if it contains bit errors. In further accordance with this example, a channel decoding process may operate to determine that the encoded frame contains bit errors and is thus bad. The encoded frame may be declared bad for other reasons as well.

As noted above, a channel decoder used in a channel decoding process may determine that the encoded frame is bad. For example, the encoded frame may have failed a cyclic redundancy check (CRC) or some other test for bit errors. In such a case, the encoded frame may be deemed bad by the channel decoder. However, even if an encoded frame is deemed bad, hard bit and soft bit information associated with bits of the encoded frame may be produced during the channel decoding process and passed to PLC stage 928. For example, a turbo decoder (e.g., turbo decoder 306 shown in FIG. 3) will produce both soft bit information (soft decisions or likelihoods concerning whether each bit of the encoded frame is a zero or a one) as well as hard bit information (hard decisions concerning whether each bit of the encoded frame is a zero or one) in association with each bit of the encoded frame. Such soft bit and hard bit information may be passed as an input to PLC stage 928.

Soft bit decoding logic 902 utilizes soft bit and hard bit information provided from a source channel decoding process (e.g., performed by JSCD stage 220) to decode one or more encoded parameters within an encoded portion (e.g., frame) to obtain one or more decoded parameters, respectively. The one or more encoded parameters may include, for example, one or more of gain, pitch, line spectral frequencies, pitch gain, fixed codebook gain, and fixed codebook excitation.

Parameter constraint logic 904 then operates to determine if one or more of the decoded parameters violates a parameter constraint associated with that particular parameter. If a decoded parameter does not violate the parameter constraint associated therewith, then parameter constraint logic 904 passes the decoded parameter to speech decoding logic 906. However, if a decoded parameter violates the parameter constraint associated therewith, then parameter constraint logic 904 operates to generate an estimate of the decoded parameter which is then passed to speech decoding logic 906.

In an embodiment, the parameter constraints may initially be equal to the off-line-designed parameter constraints optimized for the general public. As each good frame of speech signal 914 is received along with speaker identification information that identifies the target speaker for that frame, parameter constraint logic 904 may analyze speech parameter(s) associated with speech signal 904 to update parameter constraint(s) for that target speaker. For example, if it is determined that a target far-end speaker has a high-pitched voice, the constraint for the pitch period parameter for this target far-end speaker may be updated such that portions(s) of speech signal 914 associated with the target far-end speaker having a smaller pitch period do not cause a violation. Similarly, if it is determined that a target far-end speaker has a low-pitched voice, the constraint for the pitch period parameter for this target far-end speaker may be updated such that portions(s) of speech signal 914 associated with the target far-end speaker having a larger pitch period do not cause a violation.

At the termination of the communication session, the updated parameter constraint(s) may be paired with the speaker identification information that identifies the target speaker and stored in a storage component of communication device 102 or in an entity on a communication network to which communication device 102 is communicatively connected and may be retrieved in the event that the target far-end speaker is identified in a subsequent communication session.

Speech decoding logic 906 utilizes the one or more decoded parameters, or estimates thereof, output by parameter constraint logic 904 to fully decode the encoded frame, thereby producing a corresponding segment of a decoded speech signal (e.g., processed speech signal 916). In an embodiment, the estimates may be based on speech model(s) 908 of speech parameter(s) that are obtained for different target speakers. Speech model(s) 908 may be obtained in a similar manner described above with respect to FIG. 7.

Details regarding the manner in which soft bit decoding logic 902 obtains decoded parameter(s) utilizing soft and hard bit information, parameter constraint logic 904 operates to determine if each decoded parameter violates a corresponding parameter constraint and generates an estimate of each decoded parameter that is determined to violate a parameter constraint, and speech decoding logic 906 utilizes decoded parameter(s) to fully decode an encoded frame to produce a corresponding segment of a decoded speech signal may be found in aforementioned U.S. patent application Ser. No. 13/748,949, the entirety of which has been incorporated by reference as if fully set forth herein.

Accordingly, in embodiments, PLC stage 928 may operate in various ways to perform CSD-PLC based at least in part on the identity of the far-end speaker during a communication session. FIG. 10 depicts a flowchart 1000 of an example method for performing CSD-PLC based at least in part on the identity of the far-end speaker during a communication session. The method of flowchart 1000 will now be described with continued reference to FIG. 9, although the method is not limited to that implementation. Other structural and operational embodiments will be apparent to persons skilled in the relevant art(s) based on the discussion regarding flowchart 1000. It is further noted the operations of flowchart 1000 are performed in response to a determination that a portion of an encoded version of a far-end speech signal has been deemed bad.

As shown in FIG. 10, the method of flowchart 1000 begins at step 1002. In step 1002, an encoded parameter within a portion of an encoded version of a far-end speech signal is decoded based on soft bit information associated with the encoded parameter to obtain a decoded parameter. For example, as shown in FIG. 9, soft bit decoding logic 902 may decode the encoded parameter using soft bit and hard bit information. The bit information may be obtained at least in part from the channel decoding process. It is noted that, in certain embodiments, the encoded parameter may be decoded using hard bit information only.

At step 1004, a parameter constraint associated with a target speaker is obtained. For example, as shown in FIG. 9, parameter constraint logic 904 may obtain the parameter constraint associated with the target speaker. In an embodiment, parameter constraint logic 904 obtains the parameter constraint by analyzing speech parameters associated with speech signal 914 and associating the speech parameters with the target speaker using speaker identification information received by parameter constraint logic 904.

At step 1006, a determination is made as to whether or not the decoded parameter obtained during step 1004 violates the parameter constraint associated with the target speaker. For example, as shown in FIG. 9, parameter constraint logic 904 may determine whether or not the decoded parameter violates the parameter constraint associated with the target speaker. If it is determined that the decoded parameter violates the parameter constraint, flow continues to step 1008. Otherwise, flow continues to step 1010.

At step 1008, an estimate of the decoded parameter is generated, and the estimate of the decoded parameter is passed to a speech decoder for use in decoding the encoded frame. For example, as shown in FIG. 9, the estimate of the decoded parameter may be passed to speech decoding logic 906 for use in decoding the encoded frame.

At step 1010, the decoded parameter is passed to the speech decoder for use in decoding the encoded frame. For example, as shown in FIG. 9, the decoded parameter may be passed to speech decoding logic 906 for use in decoding the encoded frame.

### E. Speech Intelligibility Enhancement (SIE) Stage

Speech Intelligibility Enhancement (SIE) is a speech processing algorithm that monitors the near-end background noise and modifies the far-end speech signal to enhance the intelligibility of the far-end speech when the near-end talker is in a noisy environment. It does so by monitoring the near-end speech signal to identify the background noise of the speech signal and estimate the power level (or the spectral shape) of the near-end background noise. If the ratio of far-end speech to near-end noise is acceptable, nothing needs to be done. As the background noise level increases, SIE first tries to boost the signal level of the far-end speech by applying a linear gain to maintain the intelligibility. If the background noise is loud so that applying a linear gain to maintain an acceptable ratio of far-end speech signal to near-end background noise will cause the far-end signal to clip, then a dynamic range compressor is used to boost the softer portion of the far-end speech signal more than the louder portion. If the application of increased linear gain coupled with dynamic range compression does not achieve the desired signal-to-noise ratio, then SIE applies dispersion filtering to reduce the peak-to-average ratio for the far-end speech signal. Finally, if any of the above techniques do not provide sufficient intelligibility of the far-end speech signal, then SIE applies adaptive spectral shaping to try to boost the far-end speech formant frequencies above the near-end background noise at those frequencies to increase intelligibility of the far-end speech.

For SIE to work effectively, SIE should boost or modify only the speech portions of the far-end speech signal and not the non-speech or background noise portions; otherwise, it can make the non-speech or background noise portions of the far-end speech signal too loud and unnatural. Additionally, SIE should use only the background noise portions of the near-end speech signal as the reference to determine whether or how much to boost or spectrally shape the far-end speech signal. If the SIE mistakenly uses the active speech portions of the near-end audio signal as the reference, then during a double-talk situation, SIE will boost the far-end speech to an uncomfortably loud level.

Accordingly, both the far-end speech signal and the near-end speech signal are analyzed to determine whether particular portion(s) of the far-end speech signal and the near-end speech signal comprise active speech or background noise. As will be described below, SID can improve the identification of active speech in both the far-end speech signal and the near-end speech signal.

FIG. 11 is a block diagram 1100 of an example SIE stage 1130 in accordance with an embodiment. SIE stage 1130 comprises an implementation of SIE stage 230 of downlink speech processing logic 212 as described above in reference to FIG. 2.

SIE stage 1130 receives far-end speech signal 1108 and near-end speech signal 1110. Far-end speech signal 1108 may be a version of a far-end speech signal (e.g., speech signal 224 as shown in FIG. 2) that was previously-processed by one or more downlink speech processing stages (e.g., JSCD stage 220, speech decoding stage 222, BEC stage 226, and/or PLC stage 228 as shown in FIG. 2). Near-end speech signal 1110 may be received by one or more near-end microphones (not shown).

As shown in FIG. 11, SIE stage 1130 includes a classifier 1102, an estimator 1104 and speech intelligibility logic 1106. Classifier 1102 receives far-end speech signal 1108 and near-end speech signal 1110. Classifier 1102 may be configured to determine whether portion(s) of far-end speech signal 1108 and near-end speech signal 1110 comprise active speech or background noise based on speaker identification information.

For example, for each portion (e.g., frame) of far-end speech signal 1108, classifier 1102 may receive speaker identification information from downlink SID logic 218 that includes a measure of confidence that indicates the likelihood that the particular portion of far-end speech signal 1108 is associated with a target far-end speaker. Similarly, for each frame of near-end speech signal 1110, classifier 1102 may receive speaker identification information (e.g., from uplink SID logic, such as uplink SID logic 116 shown in FIG. 1) that includes a measure of confidence that indicates the likelihood that the particular portion of near-end speech signal 1110 is associated with a target near-end speaker. The respective measures of confidence will be relatively higher for portions including active speech and will be relatively lower for portions not including speech. Accordingly, classifier 1102 may use the respective measures of confidence to more accurately determine whether or not a particular portion of far-end speech signal 1108 and/or near-end speech signal 1110 contains active speech or background noise.

Estimator 1104 receives the respective classification for portion(s) of far-end speech signal 1108 and near-end speech signal 1110 and performs operations based on the classifications. For example, in response to determining that a portion of far-end speech signal 1108 comprises active speech, estimator 1104 may use the portion of far-end speech signal to update an estimated level associated with far-end speech signal 1108. As another example, in response to determining that a portion of near-end speech signal 1110 comprises background noise, estimator 1104 may use the portion of near-end speech signal 1110 to update an estimated level associated with the background noise portion of near-end speech signal 1110. Estimator 1104 may then determine a ratio of the estimated level associated with far-end speech signal 1108 to the estimated level associated with the background noise of near-end speech signal 1110.

Speech intelligibility logic 1106 may be configured to receive the ratio and determine whether the ratio is below a predetermined threshold. In response to determining that the ratio is below the predetermined threshold, one or more characteristics of far-end speech signal 1108 are modified to increase the intelligibility thereof. The modified far-end speech signal (e.g., processed speech signal 1114) is output for playback to the near-end user and/or provided to subsequent processing stages. On the other hand, in response to determining that the ratio is above or equal to the predetermined threshold, the characteristic(s) of far-end speech signal 1108 are maintained, as SIE is not performed in such a case.

In an embodiment, estimator 1104 is configured to determine estimated levels associated with far-end speech signal 1108 and background noise of near-end speech signal 1110 on a frequency bin by frequency bin basis. In further accordance with such an embodiment, estimator 1104 may be further configured to use such estimates to determine signal-to-noise ratios on a frequency bin by frequency bin basis. In accordance with such an embodiment, speech intelligibility logic 1106 may be configured to receive each ratio and determine whether to apply SIE based on analysis of one or more of the frequency-bin-specific ratios (e.g., by comparing each ratio to a respective predetermined threshold).

In one embodiment, speech intelligibility logic is further configured to receive a classification output from classifier 1102 that indicates whether the current portion of far-end speech signal 1108 comprises active speech or background noise. If such classification output indicates that the current portion of far-end speech signal 1108 comprises background noise, then no SIE operations will be applied to the current portion of far-end speech signal 1108 regardless of the value of the signal-to-noise ratio(s) output by estimator 1104.

In the foregoing description, SIE stage 1130 is configured to improve the intelligibility of a target far-end speaker in the presence of non-speech or background noise. However, in accordance with certain embodiments, SIE stage 1130 may also be configured to improve the intelligibility of a target far-end speaker in the presence of the speech of other far-end speakers. In particular, SIE stage 1130 may be configured to enhance the intelligibility of speech associated with a desired talker while not enhancing the speech associated with other competing talkers.

Accordingly, in embodiments, SIE stage 1130 may operate in various ways to perform SIE based at least in part on the identity of the far-end speaker and/or the near-end speaker during a communication session. FIG. 12 depicts a flowchart 1200 of an example method for performing SIE based at least in part on the identity of the far-end speaker and/or the near-end speaker during a communication session. The method of flowchart 1200 will now be described with continued reference to FIG. 11, although the method is not limited to that implementation. Other structural and operational embodiments will be apparent to persons skilled in the relevant art(s) based on the discussion regarding flowchart 1200.

As shown in FIG. 12, the method of flowchart 1200 begins at step 1202. At step 1202, a determination is made as to whether a portion of a far-end speech signal comprises active speech or noise based at least in part on the speaker identification information. For example, as shown in FIG. 11, classifier 1102 determines whether a portion of far-end speech signal 1108 comprises active speech or noise based at least in part on the speaker identification information. If it is determined that the portion of far-end speech signal 1108 comprises active speech, flow continues to step 1204. Otherwise, flow continues to step 1208.

At step 1204, a determination is made as to whether at least one ratio of an estimated level associated with the far-end speech signal to an estimated level associated with near-end noise is below a predetermined threshold. For example, as shown in FIG. 11, speech intelligibility logic 1106 determines whether at least one ratio (e.g., a ratio associated with a particular frequency range of far-end speech signal 1108) of an estimated level associated with far-end speech signal 1108 to an estimated level associated with background noise of near-end speech signal 1110 is below the predetermined threshold. If it is determined that the ratio of the estimated level associated with the far-end speech signal to the estimated level associated with the near-end noise is below the predetermined threshold, flow continues to step 1206. Otherwise, flow continue to step 1208.

As further shown in FIG. 11, the estimated level associated with far-end speech signal 1108 and the background noise of near-end speech signal 1110 are determined by estimator 1104. A method by which an estimated level associated with far-end speech signal 1108 is obtained may include determining whether a portion of far-end speech signal 1108 comprises active speech or noise based at least in part on speaker identification information. In response to determining that the portion of far-end speech signal 1108 comprises active speech, the portion of far-end speech signal 1108 is used to determine at least one estimated level associated with far-end speech signal 1108. In response to determining that the portion of far-end speech signal 1108 comprises noise, the portion of far-end speech signal 1108 is not used to determine any estimated level associated with far-end speech signal 1108.

A method by which an estimated level associated with near-end noise is obtained will be described later with reference to flowchart 1300 of FIG. 13.

At step 1206, characteristic(s) of the far-end speech signal are modified to increase the intelligibility thereof. For example, as shown in FIG. 11, speech intelligibility logic 1106 modifies the characteristic(s) of far-end speech signal 1108 to increase the intelligibility thereof.

At step 1208, the characteristic(s) of the far-end speech signal (e.g., far-end speech signal 1108) are maintained, as SIE is not performed in such a case.

FIG. 13 depicts a flowchart 1300 of an example method of implementing previously-described step 1204 of FIG. 12. The method of flowchart 1300 will now be described with continued reference to FIG. 11, although the method is not limited to that implementation. Other structural and operational embodiments will be apparent to persons skilled in the relevant art(s) based on the discussion regarding flowchart 1300.

As shown in FIG. 13, the method of flowchart 1300 begins at step 1302. At step 1302, a determination is made as to whether a portion of a near-end speech signal comprises active speech or noise based at least in part on second speaker identification information that identifies a near-end target speaker. For example, with reference to FIG. 11, classifier 1102 determines whether a portion of near-end speech signal 1110 comprises active speech or noise based at least in part on the speaker identification information that identifies the near-end target speaker. In response to determining that the portion of near-end speech signal 1110 comprises noise, flow continues to 1304. Otherwise flow continues to 1306.

At step 1304, the portion of near-end speech signal 1110 is used to determine at least one estimated level associated with the near-end noise. For example, as shown in FIG. 11, estimator 1104 uses the portion of near-end speech signal 1110 to determine at least one estimated level associated with near-end noise.

At step 1306, the portion of near-end speech signal 1110 is not used to determine any estimated level associated with the near-end noise.

### F. Acoustic Shock Protection (ASP) Stage

Acoustic shock protection (ASP) is designed to detect very loud signals (e.g., loud speech signals, non-speech signals such as network signaling tones, etc.) or a predetermined duration of such loud signals, and once detected, attenuate such loud signals to protect the hearing of a user. The level and/or type of ASP may vary depending on whether the very loud signal is a loud speech signal or a loud non-speech signal. Accordingly, ASP constantly needs to distinguish between loud speech signals and loud signaling tones and/or non-speech signals. Hence, as is the case with many of the other speech processing stages described above, SID can help ASP make a better and more accurate decision and thus achieve better performance.

FIG. 14 is a block diagram 1400 of an example ASP stage 1432 in accordance with such an embodiment. ASP stage 1432 comprises an implementation of ASP stage 232 of downlink speech processing logic 212 as described above in reference to FIG. 2.

ASP stage 1432 receives speech signal 1406. Speech signal 1406 may be a version of a far-end speech signal (e.g., speech signal 224 as shown in FIG. 2) that was previously-processed by one or more downlink speech processing stages (e.g., JSCD stage 220, speech decoding stage 222, BEC stage 226, PLC stage 228, and/or SIE stage 230 as shown in FIG. 2).

As shown in FIG. 14, ASP stage 1432 includes a classifier 1402 and attenuation logic 1404. In an embodiment, ASP stage 1432 is configured to perform ASP based on whether a portion of speech signal 1406 comprises speech or signaling tones.

In accordance with such an embodiment, classifier 1402 may be configured to determine whether portion(s) of speech signal 1406 comprise speech or signaling tones. Classifier 1402 may receive speaker identification information from downlink SID logic 218 that includes a measure of confidence that indicates the likelihood that the particular portion of speech signal 1406 is associated with a target far-end speaker. It is likely that the measure of confidence will be relatively higher for portions including speech and will be relatively lower for portions including signaling tones. Accordingly, classifier 1402 may use the measure of confidence to more accurately determine whether or not a particular portion of speech signal 1406 comprises speech or signaling tones.

Attenuation logic 1404 may be configured to apply ASP based on the classification of classifier 1402. For example, in response to classifier 1402 classifying a portion of speech signal 1406 as comprising signaling tones, attenuation logic 1404 may be configured to attenuate such portions of speech signal 1406 or replace such portions with a softer tone, silence or comfort noise.

FIG. 15 depicts a flowchart 1500 of an example method for performing ASP based on whether a portion of speech signal 1406 comprises speech or signaling tones using speaker identification. The method of flowchart 1500 will now be described with continued reference to FIG. 14, although the method is not limited to that implementation. Other structural and operational embodiments will be apparent to persons skilled in the relevant art(s) based on the discussion regarding flowchart 1500.

As shown in FIG. 15, the method of flowchart 1500 begins at step 1502. At step 1502, a determination is made as to whether a portion of a far-end speech signal comprises speech or signaling tones based at least in part on the speaker identification information. For example, as shown in FIG. 15, classifier 1502 determines whether the portion of speech signal 1406 comprises speech or signaling tones based on speaker identification information. If it is determined that the portion comprises signaling tones, flow continues to 1504. Otherwise, flow continues to 1506.

At step 1504, the portion of the far-end speech signal is attenuated or replaced. For example, as shown in FIG. 14, attenuation logic 1404 attenuates or replaces the portion of speech signal 1406.

At step 1506, ASP is not performed, and therefore, the portion of the far-end speech signal (e.g., speech signal 1406) is not attenuated or replaced.

Referring again to FIG. 14, in another embodiment, ASP stage 1432 is configured to perform ASP based on whether a portion of speech signal 1406 comprises speech or some other type of non-speech (e.g., distortion or feedback that results in a loud signal, a loud signal generated as a result of a far-end speaker dropping a communication device or tapping on the microphone of the communication device, etc.)

In accordance with such an embodiment, classifier 1402 is configured to determine whether portion(s) of speech signal 1406 comprise speech or some other type of non-speech based on speaker identification information. In this case, it is likely that the measure of confidence will be relatively higher for portions including speech and will be relatively lower for portions including non-speech. Accordingly, classifier 1402 may use the measure of confidence to more accurately determine whether or not a particular portion of speech signal comprises speech or non-speech.

Attenuation logic 1404 may be configured to determine that a level associated with a portion of speech signal 1406 exceeds an acoustic shock protection limit, and perform a type of ASP based on the classification of such portions. For example, if attenuation logic 1404 determines that portion(s) of speech signal 1406 having a signal level that exceeds an acoustic shock protection limit comprises speech, attenuation logic 1404 may apply a first amount of attenuation to such portion(s). If attenuation logic determines that portion(s) of speech signal 1406 having a signal level that that exceeds the acoustic shock protection limit comprises non-speech, attenuation logic 1404 may be configured to apply a second amount of attenuation that is greater than the first amount of attenuation to such portion(s) or simply replace such portion(s) of speech signal 1406.

FIG. 16 depicts a flowchart 1600 of an example method for performing ASP based on whether a portion of a speech signal comprises speech or non-speech using speaker identification information. The method of flowchart 1600 will now be described with continued reference to FIG. 14, although the method is not limited to that implementation. Other structural and operational embodiments will be apparent to persons skilled in the relevant art(s) based on the discussion regarding flowchart 1600.

As shown in FIG. 16, the method of flowchart 1600 begins at step 1602. At step 1602, a determination is made as to whether or not a portion of a far-end speech signal having a level that exceeds an acoustic shock protection limit comprises speech based at least in part on the speaker identification information. For example, in accordance with the method shown in FIG. 16, classifier 1402 determines whether the portion of speech signal 1406 comprises speech and attenuation logic 1404 determines whether the portion of speech signal 1406 has a level that exceeds the acoustic shock protection limit. If it is determined that the portion comprises speech and that the level associated therewith exceeds the acoustic shock protection limit, flow continues to 1604. Otherwise, flow continues to 1606.

At step 1604, a first amount of attenuation is applied to the portion of the far-end speech signal. For example, in accordance with the method shown in FIG. 16, attenuation logic 1404 applies the first amount of attenuation to the portion of speech signal 1406.

At step 1606, a second amount of attenuation is applied to the portion of the far-end speech signal that is greater than the first amount of attenuation or the second portion of the speech signal is replaced. For example, in accordance with the method shown in FIG. 16, attenuation logic 1404 applies the second amount of attenuation to the portion of speech signal 1406 or replaces the portion of speech signal 1406.

### G. Three-Dimensional (3D) Audio Production Stage

When using a communication device in speakerphone mode, 3D sound field reproduction for the near-end user (also known as virtual sound) requires 3D audio positioning. SID can provide some important features in this situation. The 3D audio positioning requires a number of audio sources to position them in the virtual audio space. The number of audio sources depends on the type of call. In the first scenario, where multiple sites (calls) are active, each site can be used as a source and can be positioned appropriately in the virtual audio space. Identifying activity of the individual site is often done with a VAD. The VAD can be improved using SID as explained above for better reliability, especially in low signal-to-noise (SNR) conditions. In the second scenario, where multiple talkers are active in the same call and at the same site (e.g., in a conference room setting), identifying separate talkers and positioning them becomes more difficult, especially if no information is available in the control stream of the call (i.e., there is no control information provided in the received speech signal). As described above, SID can be used to help identify number of talkers and their presence on frame-by-frame basis gradually during the call in such a situation. As a communication session progresses and speaker models get more robust, SID can be leveraged to provide more reliable measures of confidence as to the identity of the far-end talkers in the call. This information can be used to position far-end talkers in the virtual audio space of the near-end user.

FIG. 17 is a block diagram 1700 of an example 3D Audio Production stage 1734 in accordance with such an embodiment. 3D Audio Production stage 1734 comprises an implementation of 3D Audio Production stage 234 of downlink speech processing logic 212 as described above in reference to FIG. 2.

3D Audio Production stage 1734 is configured to receive speech signal 1704. Speech signal 1704 may be a version of a far-end speech signal (e.g., speech signal 224 as shown in FIG. 2) that was previously-processed by one or more downlink speech processing stages (e.g., JSCD stage 220, speech decoding stage 222, BEC stage 226, PLC stage 228, SIE stage 230, and/or ASP stage 232 as shown in FIG. 2).

As shown in FIG. 17, 3D Audio Production stage 1734 includes spatial region assignment logic 1702. In an embodiment, 3D Audio Production stage 1734 is configured to produce 3D audio for the near-end speaker based on speaker identification information. In particular, 3D Audio Production stage 1734 performs audio spatialization (i.e., the assignment of portions of a received speech signal to corresponding audio spatial regions). Audio spatialization, as persons skilled in the art would appreciate, enables a listener to perceive that a given talker or a given sound is emanating from a virtual region in three dimensional space. For a given number of L loudspeakers, an arbitrary number of M spatial regions can be created by applying appropriate processing (e.g., scaling and filtering) to the signals going to the various loudspeakers.

Spatial region assignment logic 1702 is configured to assign portions of speech signal 1704 to corresponding audio spatial regions based on the speaker identification information, where each portion of speech signal 1704 corresponds to a respective target far-end speaker. As described above with reference to FIG. 2, downlink SID logic 218 may determine the number of different far-end speakers. After identifying the number of users, downlink SID logic 218 may then train and update N speaker models 206. Downlink SID logic 218 may continuously determine which speaker is currently speaking and update the corresponding SID speaker model for that speaker. Downlink SID logic 218 may provide the determined number of far-end users to spatial region assignment logic 1702 via the speaker identification information.

Spatial region assignment logic 1702 provides the assigned portions as an N number of speech streams to a plurality of M spatial regions and L loudspeakers 1706 for playback, where N corresponds to the number of target far-end speakers. The N speech streams are played back in a manner such that each stream of the N speech streams is played back in its assigned audio spatial region.

In an embodiment, the audio spatial region assignment performed by spatial region assignment logic 1702 is a function of the number of loudspeakers 1706. For example, spatial region assignment logic 1702 may include a static table that includes a mapping of how to distribute the N audio streams to M spatial regions based on the L number of loudspeakers. However, this is only an example and persons skilled in the relevant art(s) will appreciate that numerous other methods for assigning portions of a speech signal to different spatial regions may be used.

In the event that downlink SID logic 218 does not recognize a target far-end speaker, or in the event that simultaneous far-end speakers cannot be distinguished, such speaker(s) may be assigned to a default region. The default region can be, for instance, a center channel (if present) or an equal distribution on all the L number of loudspeakers. Other default assignment schemes may also be used that are deemed perceptually desirable for such scenarios. The default assignment schemes described above may also be used when downlink SID logic 218 has not yet identified and resolved the various target far-end speakers (e.g., during the beginning of a communication session).

In an embodiment, spatial region assignment logic 1702 is also configured to perform adaptive cross-talk cancellation between the N speech streams. Typically, cross-talk cancellation can be done with fixed filters; however, this does not provide effective cross-talk cancellation in time-varying environments. Adaptive cross-talk cancellation is required in such scenarios. SID can also be used to improve adaptation controls for such schemes. For example, adaptive cross-talk cancellation may require the use of a VAD such that cross-talk cancellation is only performed during periods of active speech. As described above, the performance of a VAD may be improved using SID. For example, for each portion of speech signal 1704, spatial region assignment logic 1702 may receive speaker identification information that includes a measure of confidence that indicates the likelihood that the particular portion of speech signal 1704 is associated with a target far-end speaker. The measure of confidence will be relatively higher for portions including active speech and will be relatively lower for portions not including speech. Accordingly, the VAD may use the measure of confidence to more accurately determine whether or not a particular portion of speech signal 1704 contains active speech.

Accordingly, in embodiments, 3D Audio Production stage 1734 may operate in various ways to produce 3D audio for the near-end speaker based on speaker identification information. FIG. 18 depicts a flowchart 1800 of an example method for producing 3D audio for the near-end speaker based on speaker identification information during a communication session. The methods of flowchart 1800 will now be described with continued reference to FIG. 17, although the method is not limited to that implementation. Other structural and operational embodiments will be apparent to persons skilled in the relevant art(s) based on the discussion regarding flowchart 1800.

As shown in FIG. 18, the method of flowchart 1800 begins at step 1802. At step 1802, portions of a far-end speech signal are assigned to corresponding audio spatial regions based on speaker identification information, where each portion corresponds to a respective target speaker. For example, as shown in FIG. 17, spatial region assignment logic 1702 assigns portions of speech signal 1704 to corresponding audio spatial regions based on speaker identification information.

At step 1804, speech streams corresponding to the portions of the far-end speech signal are provided to a plurality of loudspeakers in a manner such that each stream of the speech streams is played back in its assigned audio spatial region. For example, as shown in FIG. 17, spatial region assignment logic 1702 provides speech streams corresponding to the portions of speech signal 1704 to a plurality of loudspeakers 1706 in a manner such that each stream of the speech streams is played back in its assigned audio spatial region.

### H. Single-Channel Noise Suppression (SCNS) Stage

FIG. 19 is a block diagram 1900 of an SCNS stage 1902 in accordance with an embodiment. SCNS stage 1902 is intended to represent a modified version of an SCNS system described in co-pending, commonly-owned U.S. patent application Ser. No. 12/897,548, entitled “Noise Suppression System and Method” and filed on Oct. 4, 2010, the entirety of which is incorporated by reference as if fully set forth herein.

SCNS stage 1902 may be included in downlink speech processing logic 212 as shown in FIG. 2. SCNS stage 1902 receives speech signal 1918. Speech signal 1918 may be a version of a far-end speech signal (e.g., speech signal 224 as shown in FIG. 2) that was previously-processed by one or more downlink speech processing stages (e.g., JSCD stage 220, speech decoding stage 222, BEC stage 226, PLC stage 228, SIE stage 230, ASP stage 232 and/or 3D Audio stage 234 as shown in FIG. 2).

As shown in FIG. 19, SCNS stage 1902 includes a frequency domain conversion block 1904, a statistics estimation block 1906, a first parameter provider block 1908, a second parameter provider block 1910, a frequency domain gain function calculator 1912, a frequency domain gain function application block 1914 and a time domain conversion block 1916.

Frequency domain conversion block 1904 may be configured to receive a time domain representation of speech signal 1918 and to convert it into a frequency domain representation of speech signal 1918.

Statistics estimation block 1906 may be configured to calculate and/or update estimates of statistics associated with speech signal 1918 and noise components of speech signal 1918 for use by frequency domain gain function calculator 1912 in calculating a frequency domain gain function to be applied by frequency domain gain function application block 1914. In certain embodiments, statistics estimation block 1906 estimates the statistics by estimating power spectra associated with speech signal 1918 and power spectra associated with the noise components of speech signal 1918.

In an embodiment, statistics estimation block 1906 estimates the statistics of the noise components during non-speech portions of speech signal 1918, premised on the assumption that the noise components will be sufficiently stationary during valid speech portions of speech signal 1918 (i.e., portions of speech 1918 that include desired speech components). In accordance with such an embodiment, statistics estimation block 1906 includes functionality that is capable of classifying portions of speech signal 1918 as speech or non-speech portions. Such functionality may be improved using SID.

For example, statistics estimation block 1906 may receive speaker identification information from downlink SID logic 218 that includes a measure of confidence that indicates the likelihood that a particular portion of speech signal 1918 is associated with a target far-end speaker. It is likely that the measure of confidence will be relatively higher for portions including speech originating from the target speaker and will be relatively lower for portions including non-speech or speech originating from a talker different from the target speaker. Accordingly, statistics estimation block 1906 cannot only use the measure of confidence to more accurately classify portions of speech signal 1906 as being speech portions or non-speech portions and estimate statistics of the noise components during non-speech portions, but it can also use the measure of confidence to classify non-target speech or other non-stationary noise as noise, which can be suppressed. This in contrast to conventional SCNS, where only stationary noise is suppressible.

First parameter provider block 1908 may be configured to obtain a value of a parameter a that specifies a degree of balance between distortion of the desired speech components and unnaturalness of residual noise components that are typically included in a noise-suppressed speech signal and to provide the value of the parameter a to frequency domain gain function calculator 1912.

Second parameter provider block 1910 may be configured to provide a frequency-dependent noise attenuation factor, Hₛ(f), to frequency domain gain function calculator 1912 for use in calculating a frequency domain gain function to be applied by frequency domain gain function application block 1914.

In certain embodiments, first parameter provider block 1908 determines a value of the parameter α based on the value of the frequency-dependent noise attenuation factor, Hₛ(f), for a particular sub-band. Such an embodiment takes into account that certain values of α may provide a better trade-off between distortion of the desired speech components and unnaturalness of the residual noise components at different levels of noise attenuation.

Frequency domain gain function calculator 1912 may be configured to obtain, for each frequency sub-band, estimates of statistics associated with speech signal 1918 and the noise components of speech signal 1918 from statistics estimation block 1906, the value of the parameter a that specifies the degree of balance between the distortion of the desired speech signal and the unnaturalness of the residual noise signal of the noise-suppressed speech signal provided by first parameter provider block 1908, and the value of the frequency-dependent noise attenuation factor, Hₛ(f) provided by second parameter provider block 1910. Frequency domain gain function calculator 1912 then uses those values to determine a signal-to-noise (SNR) ratio, which is used to calculate a frequency domain gain function to be applied by frequency domain gain function application block 1914.

Frequency domain gain function application block 1914 is configured to multiply the frequency domain representation of speech signal 1918 received from frequency domain conversion block 1904 by the frequency domain gain function constructed by frequency domain gain function calculator 1912 to produce a frequency domain representation of a noise-suppressed audio signal. Time domain conversion block 1916 receives the frequency domain representation of the noise-suppressed audio signal and converts it into a time domain representation of the noise-suppressed audio signal, which it then outputs (e.g., as processed speech signal 1920). Processed speech signal 1920 may be provided to subsequent downlink speech processing stages for further processing.

It is noted that the frequency domain and time domain conversions of the speech signal on which noise suppression occurs may occur in other downlink speech processing stages.

Additional details regarding the operations performed by frequency domain conversion block 1904, statistics estimation block 1906, first parameter provider block 1908, second parameter provider block 1910, frequency domain gain function calculator 1912, frequency domain gain function application block 1914 and time domain conversion block 1916 may be found in aforementioned U.S. patent application Ser. No. 12/897,548, the entirety of which has been incorporated by reference as if fully set forth herein. Although a frequency-domain implementation of SCNS stage 1902 is depicted in FIG. 19, it is to be understood that time-domain implementations may be used as well and may benefit from SID. Furthermore, it is noted that SCNS stage 1902 is just one example of how SCNS may be implemented. Other implementations of SCNS may also benefit from SID.

Accordingly, in embodiments, SCNS stage 1902 may operate in various ways to perform single-channel noise suppression based at least in part on the identity of the far-end speaker during a communication session. FIG. 20 depicts a flowchart 2000 of an example method for performing single-channel noise suppression based at least in part on the identity of the far-end speaker during a communication session. The method of flowchart 2000 will now be described with continued reference to FIG. 19, although the method is not limited to that implementation. Other structural and operational embodiments will be apparent to persons skilled in the relevant art(s) based on the discussion regarding flowchart 2000.

As shown in FIG. 2000, the method of flowchart 2000 begins at step 2002, in which a determination is made as to whether a portion of a far-end speech signal comprises noise only based at least in part on the speaker identification information. For example, with reference to FIG. 19, statistics estimation block 1906 determines whether a portion of speech signal 1918 comprises noise only based on speaker identification information that identifies a target far-end speaker. In accordance with embodiments described herein, noise may comprise at least one of speech from a non-target speaker, non-stationary noise, and stationary noise. If it is determined that the portion of the far-end speech signal comprises noise only, flow continues to step 2004. Otherwise, if the portion of the far-end speech signal comprises desired speech or a combination of desired speech and noise, flow continues to step 2008.

At step 2004, statistics of the noise components of the far-end speech signal are not updated.

At step 2006, noise suppression is performed on the far-end speech signal based at least on the non-updated statistics of the far-end speech signal. In accordance with an embodiment, estimated statistics of speech signal 1918 are used with an existing set of estimated statistics of noise components of speech signal 1918 to obtain an SNR ratio. Frequency domain gain function application block 1914 may perform noise suppression based on the SNR ratio.

At step 2008, statistics of noise components of the far-end speech signal are updated. For example, with reference to FIG. 19, statistics estimation block 1906 updates the statistics of noise components of a frequency domain representation of speech signal 1918.

At step 2010, noise suppression is performed on the far-end speech signal based at least on the updated statistics of the noise components. For example, with reference to FIG. 19, frequency domain gain function application block 1914 performs noise suppression on a frequency domain representation of speech signal 1918 based at least on the updated statistics of the noise components. For instance, in accordance with an embodiment, the updated statistics of the noise components are used with estimated statistics of speech signal 1918 to obtain an SNR ratio. Frequency domain gain function application block 1914 may perform noise suppression based on the SNR ratio.

### IV. Other Embodiments

The various downlink speech processing algorithm(s) described above may also use a weighted combination of speech models and/or parameters that are optimized based on a plurality of measures of confidences associated with one or more target far-end speakers. Further details concerning such an embodiment may be found in commonly-owned, co-pending U.S. patent application Ser. No. 13/965,661, entitled “Speaker-Identification-Assisted Speech Processing Systems and Methods” and filed on Aug. 13, 2013, the entirety of which is incorporated by reference as if fully set forth herein.

Additionally, it is noted that certain downlink speech processing algorithms described herein (e.g., single-channel noise suppression) may be applied during uplink speech processing (e.g., in uplink speech processing logic 106 as shown in FIG. 1).

### V. Example Computer System Implementation

The embodiments described herein, including systems, methods/processes, and/or apparatuses, may be implemented using well known computers, such as computer 2100 shown in FIG. 21. For example, elements of communication device 102, including uplink speech processing logic 106, downlink speaker processing logic 112, uplink SID logic 116, downlink SID logic 118, and elements thereof; elements of downlink SID logic 218, including feature extraction logic 202, training logic 204, speaker model(s) 206, pattern matching logic 208, mode selection logic 214, and elements thereof; downlink speech processing logic 212, JSCD stage 220, speech decoding stage 222, BEC stage 226, PLC stage 228, SIE stage 230, ASP stage 232, 3D Audio Production stage 234, and elements thereof; elements of JSCD stage 320, including turbo decoder 306, PRAB(s) 308, speech model(s) 310, and elements thereof; elements of BEC stage 526, including BER-based threshold biasing block 502, bit error detection block 504, bit error concealment block 506, and elements thereof; elements of PLC stage 728, including classifier 702, control logic 704, first PLC technique 706, second PLC technique 708, speech model(s) 710, switches 718, 720, and 722, buffer 724, and elements thereof, elements of PLC stage 928, including soft bit decoding logic 902, parameter constraint logic 904, speech decoding logic 906, speech model(s) 908, and elements thereof; elements of SIE stage 1130, including classifier 1102, estimator 1104, speech intelligibility logic 1106, and elements thereof; elements of ASP stage 1432, including classifier 1402, attenuation logic 1404, and elements thereof; elements of 3D Audio Production stage 1734, including spatial region assignment logic 1702, and elements thereof; elements of SCNS stage 1902, including frequency domain conversion block 1904, statistics estimation block 1906, first parameter provider block 1908, second parameter provider block 1910, frequency domain gain function calculator 1912, frequency domain gain function application block 1914 and time domain conversion block 1916, and elements thereof; each of the steps of flowchart 400 depicted in FIG. 4; each of the steps of flowchart 600 depicted in FIG. 6, each of the steps of flowchart 800 depicted in FIG. 8, each of the steps of flowchart 1000 depicted in FIG. 10, each of the steps of flowchart 1200 depicted in FIG. 12, each of the steps of flowchart 1300 depicted in FIG. 13, each of the steps of flowchart 1500 depicted in FIG. 15, each of the steps of flowchart 1600 depicted in FIG. 16, each of the steps of flowchart 1800 depicted in FIG. 18, each of the steps of flowchart 2000 depicted in FIG. 20, and each of the steps of flowchart 2200 depicted in FIG. 22 can be implemented using one or more computers 2100.

Computer 2100 can be any commercially available and well known computer capable of performing the functions described herein, such as computers available from International Business Machines, Apple, HP, Dell, Cray, etc. Computer 2100 may be any type of computer, including a desktop computer, a laptop computer, or a mobile device, including a cell phone, a tablet, a personal data assistant (PDA), a handheld computer, and/or the like.

As shown in FIG. 21, computer 2100 includes one or more processors (e.g., central processing units (CPUs) or digital signal processors (DSPs)), such as processor 2106. Processor 2106 may include elements of communication device 102, including uplink speech processing logic 106, downlink speaker processing logic 112, uplink SID logic 116, downlink SID logic 118, and elements thereof; elements of downlink SID logic 218, including feature extraction logic 202, training logic 204, speaker model(s) 206, pattern matching logic 208, mode selection logic 214, and elements thereof; downlink speech processing logic 212, JSCD stage 220, speech decoding stage 222, BEC stage 226, PLC stage 228, SIE stage 230, ASP stage 232, 3D Audio Production stage 234, and elements thereof; elements of JSCD stage 320, including turbo decoder 306, PRAB(s) 308, speech model(s) 310, and elements thereof; elements of BEC stage 526, including BER-based threshold biasing block 502, bit error detection block 504, bit error concealment block 506, and elements thereof; elements of PLC stage 728, including classifier 702, control logic 704, first PLC technique 706, second PLC technique 708, speech model(s) 710, switches 718, 720, and 722, buffer 724, and elements thereof, elements of PLC stage 928, including soft bit decoding logic 902, parameter constraint logic 904, speech decoding logic 906, speech model(s) 908, and elements thereof; elements of SIE stage 1130, including classifier 1102, estimator 1104, speech intelligibility logic 1106, and elements thereof; elements of ASP stage 1432, including classifier 1402, attenuation logic 1404, and elements thereof; elements of 3D Audio Production stage 1734, including spatial region assignment logic 1702, and elements thereof; elements of SCNS stage 1902, including frequency domain conversion block 1904, statistics estimation block 1906, first parameter provider block 1908, second parameter provider block 1910, frequency domain gain function calculator 1912, frequency domain gain function application block 1914 and time domain conversion block 1916, and elements thereof; or any portion or combination thereof, for example, though the scope of the example embodiments is not limited in this respect. Processor 2106 is connected to a communication infrastructure 2102, which may include, for example, a communication bus. In some embodiments, processor 2106 can simultaneously operate multiple computing threads.

Computer 2100 also includes a primary or main memory 2108, such as a random access memory (RAM). Main memory has stored therein control logic 2124 (computer software), and data.

Computer 2100 also includes one or more secondary storage devices 2110. Secondary storage devices 2110 may include, for example, a hard disk drive 2112 and/or a removable storage device or drive 2114, as well as other types of storage devices, such as memory cards and memory sticks. For instance, computer 2100 may include an industry standard interface, such as a universal serial bus (USB) interface for interfacing with devices such as a memory stick. Removable storage drive 2114 represents a floppy disk drive, a magnetic tape drive, a compact disk drive, an optical storage device, tape backup, etc.

Removable storage drive 2114 interacts with a removable storage unit 2116. Removable storage unit 2116 includes a computer usable or readable storage medium 2118 having stored therein computer software 2126 (control logic) and/or data. Removable storage unit 2116 represents a floppy disk, magnetic tape, compact disc (CD), digital versatile disc (DVD), Blu-ray disc, optical storage disk, memory stick, memory card, or any other computer data storage device. Removable storage drive 2114 reads from and/or writes to removable storage unit 2116 in a well-known manner.

Computer 2100 also includes input/output/display devices 2104, such as monitors, keyboards, pointing devices, etc.

Computer 2100 further includes a communication or network interface 2120. Communication interface 2120 enables computer 2100 to communicate with remote devices. For example, communication interface 2120 allows computer 2100 to communicate over communication networks or mediums 2122 (representing a form of a computer usable or readable medium), such as local area networks (LANs), wide area networks (WANs), the Internet, etc. Network interface 2120 may interface with remote sites or networks via wired or wireless connections. Examples of communication interface 2122 include but are not limited to a modem (e.g., for 3G and/or 4 G communication(s)), a network interface card (e.g., an Ethernet card for Wi-Fi and/or other protocols), a communication port, a Personal Computer Memory Card International Association (PCMCIA) card, a wired or wireless USB port, etc.

Computer 2100 further includes a communication or network interface 2120. Communication interface 2120 enables computer 2100 to communicate with remote devices. For example, communication interface 2120 allows computer 2100 to communicate over communication networks or mediums 2122 (representing a form of a computer usable or readable medium), such as local area networks (LANs), wide area networks (WANs), the Internet, etc. Network interface 2120 may interface with remote sites or networks via wired or wireless connections. Examples of communication interface 2122 include but are not limited to a modem (e.g., for 3G and/or 4 G communication(s)), a network interface card (e.g., an Ethernet card for Wi-Fi and/or other protocols), a communication port, a Personal Computer Memory Card International Association (PCMCIA) card, a wired or wireless USB port, etc.

Control logic 2128 may be transmitted to and from computer 2100 via the communication medium 2122.

Any apparatus or manufacture comprising a computer useable or readable medium having control logic (software) stored therein is referred to herein as a computer program product or program storage device. This includes, but is not limited to, computer 2100, main memory 2108, secondary storage devices 2110, and removable storage unit 2116. Such computer program products, having control logic stored therein that, when executed by one or more data processing devices, cause such data processing devices to operate as described herein, represent embodiments.

The disclosed technologies may be embodied in software, hardware, and/or firmware implementations other than those described herein. Any software, hardware, and firmware implementations suitable for performing the functions described herein can be used.

### VI. Conclusion

In summary, downlink speech processing logic 212 may operate in various ways to process a speech signal in a manner that takes into account the identity of identified target far-end speaker(s). FIG. 22 depicts a flowchart 2200 of an example method for processing a speech signal based on an identity of far-end speaker(s) during a communication session. The method of flowchart 2200 will now be described with reference to FIG. 2, although the method is not limited to that implementation. Other structural and operational embodiments will be apparent to persons skilled in the relevant art(s) based on the discussion regarding flowchart 2000.

As shown in FIG. 22, the method of flowchart 2200 begins at step 2202, in which speaker identification information that identifies a target speaker is received by one or more of a plurality of speech signal processing stages in a downlink path of a communication device. For example, with reference to FIG. 2, at least one of JSCD stage 220, speech decoding stage 222, BEC stage, 226, PLC stage, 228, SIE stage, 230, ASP stage 232, and/or 3D Audio Production Stage 234 of downlink speech processing logic 212 receives speaker identification information from downlink SID logic 218. SCNS stage 1902 may also receive speaker identification information from downlink SID logic 218.

At step 2204, a respective version of a speech signal is processed by each of the one or more speech signal processing stages in a manner that takes into account the identity of the target speaker. For example, with reference to FIG. 2, speech signal 224 (or a version thereof) is processed in a manner that takes into account the identity of the target far-end speaker by at least one JSCD stage 220, speech decoding stage 222, BEC stage, 226, PLC stage, 228, SIE stage, 230, ASP stage 232, and/or 3D Audio Production Stage 234 of downlink speech processing logic 212. Speech signal 224 (or a version thereof) may also be processed in a manner that takes into account the identity of the target far-end speaker by SCNS stage 1902.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method, comprising:
receiving, by one or more speech signal processing stages in a downlink path of a communication device, speaker identification information that identifies a target speaker; and
processing, by each of the one or more speech signal processing stages, a respective version of a speech signal in a manner that takes into account the identity of the target speaker, wherein the one or more speech signal processing stages include at least one of:
a joint source channel decoding stage,
a bit error concealment stage,
a packet loss concealment stage,
a noise suppression stage,
a speech intelligibility enhancement stage,
an acoustic shock protection stage, and
a three-dimensional (3D) audio production stage.

2. The method of claim 1, wherein processing a respective version of the speech signal by the joint source channel decoding stage comprises:
obtaining a speech model that is specific to the target speaker, the speech model indicating how one or more speech parameters associated with the target speaker changes over time; and
performing joint source channel decoding operations on the respective version of the speech signal using the obtained speech model.

3. The method of claim 1, wherein processing a respective version of the speech signal by the bit error concealment stage comprises:
analyzing a portion of the respective version of the speech signal to detect whether the portion includes a distortion that will be audible during playback thereof, the detection being based at least in part on the speaker identification information; and
concealing the distortion in the respective version of the speech signal in response to determining that the respective version of the speech signal includes the distortion.

4. The method of claim 1, wherein processing a respective version of the speech signal by the packet loss concealment stage comprises:
classifying at least a portion of the respective version of the speech signal using the speaker identification information; and
selectively applying one of a plurality of packet loss concealment techniques to replace a lost portion of the respective version of the speech signal based on the classification.

5. The method of claim 1, wherein processing a respective version of the speech signal by the packet loss concealment stage comprises:
in response to determining that a portion of an encoded version of the respective version of the speech signal has been deemed bad:
decoding an encoded parameter within the portion of the encoded version based on soft bit information associated with the encoded parameter to obtain a decoded parameter;
obtaining a parameter constraint associated with the target speaker;
determining if the decoded parameter violates the parameter constraint associated with the target speaker;
in response to determining that the decoded parameter violates the parameter constraint, generating an estimate of the decoded parameter, and passing the estimate of the decoded parameter to a speech decoder for use in decoding the portion of the encoded version; and
in response to determining that the decoded parameter does not violate the parameter constraint, passing the decoded parameter to the speech decoder for use in decoding the portion of the encoded version.

6. The method of claim 1, wherein processing a respective version of the speech signal by the speech intelligibility enhancement stage comprises:
determining whether a portion of the respective version of the speech signal comprises active speech or noise based at least in part on the speaker identification information;
in response to at least determining that the portion of the respective version of the speech signal comprises active speech, determining whether at least one ratio of an estimated level associated with the respective version of the speech signal to an estimated level associated with near-end noise is below a predetermined threshold; and
in response to at least determining that the portion of the respective version of the speech signal comprises active speech and determining that the at least one ratio is below the predetermined threshold, modifying one or more characteristics of the respective version of the speech signal to increase the intelligibility thereof.

7. The method of claim 6, wherein the estimated level associated with the near-end noise is obtained by:
determining whether a portion of a near-end speech signal comprises active speech or noise based at least in part on second speaker identification information that identifies a second target speaker; and
in response to at least determining that the portion of the near-end speech signal comprises noise, using the portion of the near-end speech signal to determine the estimated level associated with the near-end noise.

8. The method of claim 1, wherein processing a respective version of the speech signal by the acoustic shock protection stage comprises:
determining whether a portion of the respective version of the speech signal comprises speech or signaling tones based at least in part on the speaker identification information; and
in response to at least determining that the portion of the respective version of the speech signal comprises signaling tones, attenuating or replacing the portion of the respective version of the speech signal.

9. The method of claim 1, wherein processing a respective version of the speech signal by the acoustic shock protection stage comprises:
determining whether or not a portion of the respective version of the speech signal having a level that exceeds an acoustic shock protection limit comprises speech based at least in part on the speaker identification information;
in response to determining that the portion of the respective version of the speech signal comprises speech, applying a first amount of attenuation to the portion of the respective version of the speech signal; and
in response to determining that the portion of the respective version of the speech signal does not comprise speech, performing one of: applying a second amount of attenuation to the portion of the respective version of the speech signal that is greater than the first amount of attenuation or replacing the portion of the respective version of the speech signal.

10. The method of claim 1, wherein processing a respective version of the speech signal by the 3D audio production stage comprises:
assigning portions of the respective version of the speech signal to corresponding audio spatial regions based on the speaker identification information, each portion corresponding to a respective target speaker; and
providing speech streams corresponding to the portions of the respective version of the speech signal to a plurality of loudspeakers in a manner such that each stream of the speech streams is played back in its assigned audio spatial region.

11. A communication device, comprising:
downlink speech processing logic comprising one or more speech signal processing stages, each of the one or more speech signal processing stages being configured to receive speaker identification information that identifies a target speaker and process a respective version of the speech signal in a manner that takes into account the identity of the target speaker, the one or more speech signal processing stages including at least one of:
a joint source channel decoding stage,
a bit error concealment stage,
a packet loss concealment stage,
a noise suppression stage,
a speech intelligibility enhancement stage,
an acoustic shock protection stage, and
a 3D audio production stage.

12. The communication device of claim 11, wherein the joint source channel decoding stage is configured to:
obtain a speech model that is specific to the target speaker, the speech model indicating how one or more speech parameters associated with the target speaker changes over time; and
perform joint source channel decoding operations on the respective version of the speech signal using the obtained speech model.

13. The communication device of claim 11, wherein the bit error concealment stage is configured to:
analyze a portion of the respective version of the speech signal to detect whether the portion includes a distortion that will be audible during playback thereof, the detection being based at least in part on the speaker identification information; and
conceal the distortion in the respective version of the speech signal in response to a determination that the respective version of the speech signal includes the distortion.

14. The communication device of claim 11, wherein the packet loss concealment stage is configured to:
obtain a speech model that is specific to the target speaker, the speech model indicating how one or more first speech parameters associated with the target speaker changes over time;
detect a packet loss in a portion of the respective version of the speech signal; and
conceal the packet loss based on one or more second speech parameters that are derived using the speech model.

15. The communication device of claim 11, wherein the packet loss concealment stage is configured to:
in response to a determination that a portion of an encoded version of the respective version of the speech signal has been deemed bad:
decode an encoded parameter within the portion of the encoded version based on soft bit information associated with the encoded parameter to obtain a decoded parameter;
obtain a parameter constraint associated with the target speaker;
determine if the decoded parameter violates the parameter constraint associated with the target speaker;
in response to a determination that the decoded parameter violates the parameter constraint, generate an estimate of the decoded parameter, and pass the estimate of the decoded parameter to a speech decoder for use in decoding the portion of the encoded version; and
in response to a determination that the decoded parameter does not violate the parameter constraint, pass the decoded parameter to the speech decoder for use in decoding the portion of the encoded version.

16. The communication device of claim 11, wherein the speech intelligibility enhancement stage is configured to:
determine whether a portion of the respective version of the speech signal comprises active speech or noise based at least in part on the speaker identification information;
in response to at least a determination that the portion of the respective version of the speech signal comprises active speech, determine whether a ratio of an estimated level associated with the respective version of the speech signal to an estimated level associated with near-end background noise is below a predetermined threshold; and
in response to at least a determination that the portion of the respective version of the speech signal comprises active speech and a determination that the ratio is below the predetermined threshold, modify one or more characteristics of the respective version of the speech signal to increase the intelligibility of the respective version of the speech signal.

17. The communication device of claim 16, wherein the estimated level of the near-end noise is obtained by:
determining whether a portion of a near-end speech signal comprises active speech or noise based at least in part on second speaker identification information that identifies a second target speaker; and
in response to at least determining that the portion of the near-end speech signal comprises noise, using the portion of the near-end speech signal to determine the estimated level of the near-end noise.

18. The communication device of claim 11, wherein the acoustic shock protection stage is configured to:
determine whether a portion of the respective version of the speech signal comprises speech or signaling tones based at least in part on the speaker identification information; and
in response to at least a determination that the portion of the respective version of the speech signal comprises signaling tones, attenuate or replace the portion of the respective version of the speech signal.

19. The communication device of claim 11, the acoustic shock protection stage is configured to:
determine whether or not a portion of the respective version of the speech signal having a level that exceeds an acoustic shock protection limit comprises speech based at least in part on the speaker identification information;
in response to a determination that the portion of the respective version of the speech signal comprises speech, apply a first amount of attenuation to the portion of the respective version of the speech signal; and
in response to a determination that the portion of the respective version of the speech signal does not comprise speech, perform one of applying a second amount of attenuation to the portion of the respective version of the speech signal that is greater than the first amount of attenuation or replacing the portion of the respective version of the speech signal.

20. A computer readable storage medium having computer program instructions embodied in said computer readable storage medium for enabling a processor to process a speech signal, the computer program instructions including instructions executable to perform operations comprising:
receiving, by one or more speech signal processing stages in a downlink path of a communication device, speaker identification information that identifies a target speaker; and
processing, by each of the one or more speech signal processing stages, a respective version of the speech signal in a manner that takes into account the identity of the target speaker, wherein the one or more speech signal processing stages include at least one of:
a joint source channel decoding stage,
a bit error concealment stage,
a packet loss concealment stage,
a noise suppression stage,
a speech intelligibility enhancement stage,
an acoustic shock protection stage, and
a 3D audio production stage.
